(19) United States
(12) Patent Application Publication
(10) Pub. No.: US 2026/0272758 A1
(43) Pub. Date: Sep. 17, 2026

(54) SYSTEM

(71) Applicant: SoftBank Group Corp., Tokyo (JP)

(72) Inventor: Tadashi ABE, Tokyo (JP)

(73) Assignee: SoftBank Group Corp., Tokyo (JP)

(21) Appl. No.: 19/553,635

(22) Filed: Mar. 2, 2026

Related U.S. Application Data
(60) Provisional application No. 63/769,916, filed on Mar. 11, 2025.

(51) Int. Cl. A61H 3/06; G01C 21/20; G06V 10/82

(52) U.S. Cl. CPC A61H 3/061; G01C 21/20; G06V 10/82

(57) ABSTRACT

A system comprising a processor, a camera unit, and an audio output unit, the system being configured to support independent living of a visually impaired user, wherein the processor is configured to receive image data captured in real time by the camera unit representing a surrounding environment of the user, wherein the processor is configured to analyze the image data to generate analysis information, and wherein the audio output unit is configured to provide the analysis information as audio to the user.

### CROSS-REFERENCE TO RELATED APPLICATION

This application claims the benefit of U.S. Provisional Application No. 63/769,916 filed on Mar. 11, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional assistive technologies for visually impaired users, such as white canes, simple obstacle-detection devices, or static screen readers, are limited in their ability to provide rich, real-time understanding of the user's surrounding environment. Many existing systems are unable to capture and interpret complex scenes, recognize faces or text in the environment, or deliver context-aware guidance in a timely and intuitive manner. In particular, such systems often fail to (i) continuously capture a wide field of view corresponding to the user's natural visual field, (ii) perform integrated analysis of multiple types of information such as objects, faces, and text, and (iii) provide interactive, personalized audio guidance that responds to user voice commands and changing situations. As a result, visually impaired users may experience difficulties in safe navigation, social interaction, and access to information in daily life, which restricts their independence. Therefore, there is a need for a system that can capture the surrounding environment in real time, analyze the captured image data using advanced machine learning techniques, and provide the analysis result as intuitive audio information, while also supporting interactive voice-based queries and continuous personalization.

### SUMMARY

In order to solve the above-described problems, a system is provided that comprises a processor, a camera unit, and an audio output unit. The processor is configured to receive image data captured in real time by the camera unit representing a surrounding environment of a visually impaired user, and to analyze the image data to generate analysis information. The audio output unit is configured to provide the analysis information as audio to the user. The camera unit includes a wide-angle lens and is configured to continuously capture a wide range of the environment within a field of view of the user. The processor is configured to execute a plurality of machine learning algorithms, including object recognition, face recognition, text recognition, and scene analysis, on the image data, so as to identify relevant environmental elements such as obstacles, stairs, doors, traffic signals, known persons, and signs. The audio output unit is configured to provide an audio guide to the user by using bone conduction technology, thereby enabling the user to receive guidance without blocking ambient sounds. Furthermore, the processor is configured to provide an interface that receives voice commands from the user and to provide information responsive to a question from the user by referring to at least one of the Internet and an internal database. The processor is also configured to perform an interactive dialogue function that is customizable according to needs of the user and to improve accuracy of information provision through continuous learning and updating. Through these means, the system enables rich, context-aware, and personalized audio guidance to support independent living of visually impaired users.

The term “system” refers to an integrated combination of hardware and software components that cooperate to perform the functions described in the claims, including capturing, processing, and outputting information to support a visually impaired user. The term “processor” refers to one or more hardware processing devices, such as a central processing unit (CPU), graphics processing unit (GPU), digital signal processor (DSP), dedicated AI accelerator, or any combination thereof, configured to execute instructions and perform data processing operations as described in the claims.

The term “camera unit” refers to a hardware imaging device, including at least one image sensor and associated optics, such as a wide-angle lens, that is configured to capture image data representing a surrounding environment of a user in real time.

The term “audio output unit” refers to a hardware component or set of components configured to generate audible output for a user, including but not limited to speakers, bone conduction transducers, amplifiers, and associated circuitry.

The term “visually impaired user” refers to a person having a partial or complete loss of vision, including blindness and low vision, who benefits from assistive functions provided by the system.

The term “image data” refers to digital data representing at least one captured image or sequence of images of the surrounding environment, including still images, video frames, or any other visual information suitable for processing by the processor.

The term “analysis information” refers to information generated by the processor based on processing of the image data, including results of object recognition, face recognition, text recognition, scene analysis, or any combination thereof.

The term “wide-angle lens” refers to an optical element or assembly having a field of view wider than that of a standard lens, and configured to capture a wide range of the environment corresponding substantially to or exceeding a typical human visual field.

The term “object recognition” refers to a process performed by the processor in which objects present in the image data, such as pedestrians, vehicles, stairs, doors, traffic signals, or obstacles, are detected, classified, and optionally localized.

The term “face recognition” refers to a process performed by the processor in which faces present in the image data are detected, analyzed, and optionally matched against stored facial data to identify or verify persons.

The term “text recognition” refers to a process, including optical character recognition (OCR), performed by the processor in which textual information present in the image data, such as characters, words, or sentences on signs, boards, or documents, is detected and converted into machine-readable text.

The term “scene analysis” refers to a process performed by the processor in which overall characteristics, context, or structure of the captured environment are inferred from the image data, including spatial relationships among objects, layout of the surroundings, and identification of relevant regions or areas.

The term “bone conduction technology” refers to a sound transmission method in which vibrations generated by a transducer are conducted through bones of the user's skull to the inner ear, thereby enabling perception of audio without blocking or relying solely on the outer ear canal.

The term “voice commands” refers to spoken utterances provided by the user, captured by a microphone, and interpreted by the processor as instructions or queries for controlling or interacting with the system.

The term “interface that receives voice commands” refers to hardware and software components, including at least a microphone and speech processing functions, configured to capture, recognize, and interpret voice commands spoken by the user.

The term “Internet” refers to a global network of interconnected computer systems and servers through which the processor can obtain external information or services used to respond to user queries.

The term “internal database” refers to one or more data stores accessible by the processor and maintained locally within the system or within a server associated with the system, containing information used to respond to user queries or to support analysis and guidance functions.

The term “interactive dialogue function” refers to a capability of the processor to engage in multi-step, context-aware exchanges with the user, including receiving voice input, generating responsive output, maintaining conversational context, and adapting subsequent responses based on prior interactions.

The term “customizable according to needs of the user” refers to an ability of the system to modify or adapt at least one operational parameter, such as language, detail level, types of guidance, or response style, based on explicit user settings, inferred preferences, or usage history.

The term “continuous learning and updating” refers to processes by which the processor adjusts models, parameters, or stored data over time, based on new data, user interactions, or feedback, in order to improve accuracy, relevance, or personalization of information provision.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

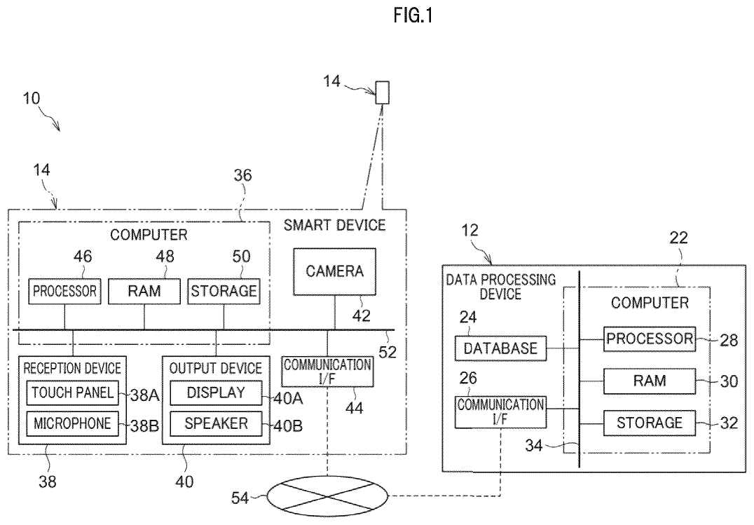

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

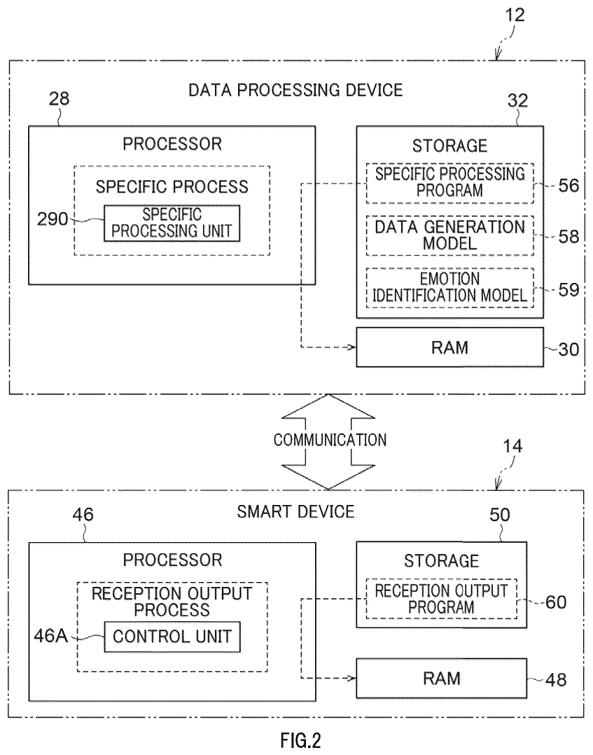

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional assistive systems for visually impaired users typically perform fixed, rule-based conversions from sensor data to spoken messages. Such systems often execute computer vision, speech processing, and audio output in independent modules that are loosely coupled through simple application logic. As a result, these systems suffer from several technical limitations from the standpoint of computer technology.

First, existing systems generally lack an integrated mechanism to convert high-dimensional, heterogeneous sensor data streams (for example, video frames, recognized text, and external service data) into compact, structured scene representations that can be efficiently consumed by downstream language generation components. Instead, they often forward raw or minimally processed recognition results to a text-generation module or directly to text-to-speech, which leads to redundant or low-relevance information being spoken. This imposes unnecessary computational load on processors and communication networks and increases latency, especially in mobile or edge-to-cloud architectures.

Second, when a large language model or other generative AI model is used, conventional systems rely on hand-crafted, static prompts or generic query formats that do not systematically exploit the underlying scene structure, user attributes, or dialogue context. Consequently, the generative model may produce verbose, inconsistent, or safety-irrelevant guidance. From a computing perspective, this causes inefficient utilization of the generative model's capacity, suboptimal token usage, and additional post-processing overhead to sanitize or shorten the output. The lack of a programmatic feedback loop to verify and constrain generated content also makes it difficult to guarantee that outputs satisfy predefined safety and format constraints.

Third, traditional dialogue interfaces in assistive systems handle user queries (such as navigation requests or information requests) independently of real-time scene understanding. Dialogue management logic is commonly separated from perception pipelines, resulting in fragmented processing paths. This architectural separation leads to redundant computations, repeated external API calls, and an inability to reuse already computed scene information when answering user questions, thereby increasing processing time and resource consumption of the overall computing system.

Fourth, existing personalization mechanisms for assistive guidance are primarily based on static user profiles or simple configuration parameters. They do not systematically incorporate long-term user behavior logs and dialogue histories into the internal control logic that governs which information is extracted from sensor data, how prompts are constructed for the generative model, and how outputs are prioritized. From a technical standpoint, this limits the system's ability to adapt its internal data flows and processing parameters over time, resulting in repeated computation of low-utility outputs, unnecessary re-generation of similar guidance, and suboptimal scheduling of safety-critical versus non-critical audio messages.

Thus, there is a need for a computer-implemented system and processing architecture that (i) transforms raw sensor data into a structured scene representation optimized for downstream generative processing, (ii) automatically constructs and refines prompt sentences for a generative AI model based on scene structure, user attributes, and dialogue context, (iii) programmatically verifies and filters generative outputs according to safety and formatting constraints before conversion to speech, and (iv) adaptively updates internal control parameters using user behavior history and past dialogue data, thereby improving computational efficiency, reducing latency, and enhancing the reliability and relevance of audio guidance for visually impaired users.

The specific processing by the specific processing unit 290 of the data processing device 12 in Example 1 is realized by the following means.

The present invention provides a server comprising a processor and a memory storing instructions which, when executed by the processor, cause the processor to receive environment image data captured by an imaging device associated with a user, execute learned discrimination processing on the environment image data using one or more discrimination-use learned models to perform object recognition, face recognition, and character recognition, integrate recognition results over time to generate structured scene information including types, positions, and distances of objects, presence and relative positions of known persons, and character information, select and prioritize elements of the structured scene information based on user attribute information so as to generate scene interpretation information that emphasizes safety-related content, generate a prompt sentence as text-format input data for a generative AI model based on the scene interpretation information and dialogue history information, input the prompt sentence to the generative AI model and obtain a natural-language guidance text, verify the guidance text against predetermined safety criteria and expression-length constraints and, when necessary, modify or filter the guidance text to comply with the criteria and constraints, convert the verified guidance text into audio data and transmit the audio data for output by an acoustic output device of a bone-conduction type, receive utterance audio from the user and convert the utterance audio into a character string by speech recognition processing, extract a requested content of the user by intent analysis processing, obtain external or internal information corresponding to the requested content, integrate the obtained information with the structured scene information to generate dialogue response information, generate a further prompt sentence including the dialogue response information, input the further prompt sentence to the generative AI model to obtain a response text, verify and, when necessary, modify the response text according to safety and formatting rules prior to audio conversion, and update, based on behavior history information of the user and past dialogue information, one or more control parameters that determine a detail level, a priority, and a linguistic expression style of content included in subsequent scene interpretation information and prompt sentences. This enables the computing system to transform heterogeneous sensor and context data into a compact structured representation optimized for generative processing, to construct and constrain prompt sentences and generative outputs in a programmatic feedback loop, and to adapt internal processing behavior over time based on user interaction data, thereby improving computational efficiency, reducing latency, and enhancing the safety, consistency, and relevance of audio guidance provided to visually impaired users.

The term “environment image data” refers to digital image data representing a physical environment around a user, including still images or video frames captured over time by an imaging device such as a camera.

The term “imaging device” refers to a hardware image sensor arrangement, including optics and associated circuitry, configured to capture optical information from a physical environment and to output corresponding digital image data.

The term “communication line” refers to any wired or wireless communication channel, network, or link over which digital data can be transmitted between a terminal apparatus and a server apparatus.

The term “information processing apparatus” refers to an electronic computing system, such as a server or group of servers, that executes stored instructions to perform data processing, analysis, and control operations.

The term “processor” refers to one or more hardware processing units, such as a central processing unit, graphics processing unit, digital signal processor, or any combination thereof, configured to execute computer-readable instructions.

The term “learned discrimination processing” refers to processing that applies one or more machine-learned models to input data to classify, detect, or recognize patterns or entities in the input data.

The term “object recognition processing” refers to a type of learned discrimination processing that detects and identifies physical objects in image data and outputs information such as object categories and locations.

The term “person face recognition processing” refers to a type of learned discrimination processing that detects faces in image data, extracts facial features, and identifies or verifies persons by comparing the features to stored facial data.

The term “character recognition processing” refers to a type of learned discrimination processing that detects and recognizes text characters or words in image data and outputs corresponding digital text data.

The term “structured scene information” refers to data in a structured format that represents a scene, including one or more attributes such as types, positions, and distances of objects, presence and relative positions of known persons, and recognized text information.

The term “user attribute information” refers to data indicating one or more characteristics or preferences of a user, including but not limited to language preference, desired level of detail, and audio output settings.

The term “scene interpretation information” refers to data derived from structured scene information and user attribute information, in which scene elements are selected, filtered, or prioritized according to importance or relevance, such as safety-related importance.

The term “generative AI model” refers to a machine-learned model, such as a large language model or other generative model, configured to generate natural-language text or other content in response to input data.

The term “prompt sentence” refers to a text-format input sequence provided to a generative AI model, the text-format input sequence including instructions, context, or data that guide the content and style of the model's generated output.

The term “natural-language guidance text” refers to generated text expressed in a human language and intended to provide guidance or instructions to a user regarding the user's environment or actions.

The term “acoustic output device of a bone-conduction type” refers to an audio transducer configured to transmit sound vibrations through a user's bones, such as the skull, to the inner ear without substantially blocking ambient sound.

The term “utterance audio” refers to audio data representing spoken speech produced by a user and captured by one or more microphones.

The term “speech recognition processing” refers to processing that converts audio data representing spoken language into corresponding digital text data.

The term “intent analysis processing” refers to processing that analyzes a text representation of a user's utterance to determine a requested content or purpose of the user's utterance.

The term “external information source” refers to a data source outside the information processing apparatus, such as a network-accessible service, that can provide information in response to a query.

The term “internal information source” refers to a data source within the information processing apparatus, such as a local database or memory, that stores information accessible by the processor.

The term “dialogue history information” refers to stored data representing past interactions between a user and the system, including prior user utterances, system responses, and associated context.

The term “response text” refers to natural-language text generated by a system in response to a user request or query, and intended for delivery to the user.

The term “behavior history information” refers to data representing past behaviors of a user in relation to system outputs, including reactions to guidance, navigation patterns, and usage patterns.

The term “control parameters” refers to values stored or computed by the system that determine how processing is performed, including but not limited to parameters specifying detail level, priority ordering, and linguistic expression style of generated outputs.

The term “detail level” refers to a degree or granularity of descriptive information included in guidance text or response text.

The term “priority” refers to a relative importance level assigned to items of information or messages, used to determine output order, emphasis, or interruption behavior.

The term “linguistic expression style” refers to characteristics of natural-language output, including but not limited to language, formality, sentence length, and phrasing pattern.

The term “position information acquisition function” refers to processing that acquires a current location of a user or device, for example using satellite positioning, network-based positioning, or sensor-based estimation.

The term “route information acquisition function” refers to processing that acquires travel route data between locations, such as path segments, turns, and distances, from map data or navigation data.

The term “navigation request” refers to a type of user request determined by intent analysis processing in which the user asks for route guidance, directions, or location-related assistance.

In one embodiment, the system includes a terminal worn by a user and a server disposed in a network environment. The terminal includes at least an imaging device, a microphone, a communication interface, a bone-conduction acoustic output device, and a local processor. The server includes at least a processor, a memory, a non-volatile storage device, and a network interface. The server executes one or more software modules that implement discrimination-use learned models, a generative AI model, a prompt-generation module, a verification module, a dialogue management module, and a personalization module. The terminal captures environment image data and user utterance audio and cooperates with the server to provide customized audio guidance. The terminal controls a high-resolution, wide-angle camera as the imaging device. The terminal may employ, for example, a complementary metal-oxide semiconductor image sensor with a field of view equal to or greater than approximately 120 degrees and a resolution equal to or greater than approximately 1920×1080 pixels. The terminal configures the imaging device through driver software of an embedded operating system such as a mobile operating system or an embedded Linux system. The terminal may use an image signal processor integrated in a system-on-chip to perform automatic exposure adjustment, white-balance adjustment, noise reduction, low-light compensation using infrared sensing, and electronic image stabilization. The terminal converts the sensor output into compressed video using a hardware video encoder, such as an encoder implementing a widely used video compression standard.

The terminal transmits the compressed image data and metadata to the server via a wireless communication link such as a mobile cellular network interface or a wireless local area network interface. The terminal establishes a secure communication session using a transport-layer security protocol. The terminal also receives audio data from the server and outputs the audio data through bone-conduction transducers driven by a local digital-to-analog converter and amplifier circuitry. The terminal thereby physically stimulates bones of the user's head, such that the user receives guidance audio while ambient environmental sounds remain perceptible.

The server receives the compressed image data through the network interface and reconstructs video frames by executing a multimedia decoding library such as a widely used open-source media framework. The server then performs discrimination-use learned processing on the reconstructed frames using one or more learned models implemented, for example, in a deep-learning framework. In one embodiment, the server represents each frame as a tensor and stores the tensor in a graphics processing unit memory.

The server executes an object recognition model using a convolutional neural network architecture that includes a backbone feature extractor (for example, a multi-stage convolutional stack with residual connections), a feature pyramid network, and one or more detection heads. The server inputs the tensorized image to this model and obtains a set of bounding boxes, object class probabilities, and confidence scores. The server executes non-maximum suppression on the bounding boxes using a predetermined intersection-over-union threshold, thereby producing a compact set of object instances such as pedestrian, vehicle, traffic light, stair, door, or obstacle. The server further computes approximate distance values for each object based on bounding box sizes, camera intrinsic parameters, and, where available, depth cues or motion parallax.

The server executes face recognition processing using two learned models: a face detection model and a face embedding model. The server may employ, for example, a multi-task cascaded convolutional network to detect facial regions, followed by a deep metric-learning network that maps each face crop to an embedding vector in a feature space. The server stores a plurality of reference embedding vectors for known persons in a database, together with user identifiers. The server computes cosine similarity scores between a detected face embedding and all relevant reference embeddings and determines that the detected face corresponds to a known person when a similarity exceeds a predetermined threshold. The server thereby obtains identity labels and relative positions for known persons in the scene.

The server executes character recognition processing by first detecting text regions in the image frames. The server may employ a fully convolutional text detection network that predicts text region heatmaps and bounding polygons. The server rectifies and normalizes each detected region and then executes an optical character recognition model, which may be implemented as a convolutional-recurrent architecture with a connectionist temporal classification loss or as a transformer-based sequence model. The server outputs recognized character strings together with language tags and confidence values.

The server integrates the outputs of object recognition, face recognition, and character recognition into structured scene information. The server stores this structured scene information in a data structure such as a tree or graph representation, where each node represents an entity (for example, object, person, or text segment) and has attributes including type, bounding coordinates, relative position (for example, “left,” “right,” “ahead”), estimated distance, confidence scores, and time stamps. The server further stores global scene attributes such as current frame index, camera pose if available, and environmental conditions. In addition, the server links successive frames over time by associating entity identifiers using a multi-object tracking algorithm that may employ Kalman filtering and data association based on spatial proximity and appearance similarity. This yields temporally smoothed trajectories for moving objects and persons and reduces flicker and instability in recognition results.

The server then generates scene interpretation information by selecting and prioritizing elements from the structured scene information. The server accesses user attribute information, such as a language code, a maximum preferred phrase length, and a safety sensitivity parameter, from a user profile database stored in a non-volatile storage device. The server applies a rule set that assigns an importance score to each entity based on factors including entity type (for example, higher for obstacles, vehicles, traffic lights, stairs, and curbs), distance (higher for closer entities), relative motion (higher for moving entities approaching the user), and recognition confidence. The server also considers whether an entity has been announced recently by consulting dialogue history information. The server excludes or de-emphasizes entities with low importance or recently announced entities with unchanged state. As a result, the server produces a reduced set of scene elements that are most relevant for safety and navigation. The server packages these elements and metadata into scene interpretation information, such as a compact textual summary or a structured record.

The server uses the scene interpretation information and dialogue history information to construct a prompt sentence for a generative AI model. The server executes a prompt-generation module that converts the structured data into a natural-language input sequence while embedding explicit instructions. The server may adopt a template-based algorithm that maps entity types and attributes to phrase segments and then concatenates them with control instructions. For example, the server may generate a prompt sentence such as: “You are assisting a visually impaired user. Current scene: a crosswalk is 4 meters ahead; the pedestrian signal is green; one car is stopped 10 meters away; stairs are on the left at 6 meters; no obstacles directly in front. The user prefers concise English guidance. In at most two short sentences, tell the user what to do next, focusing on safety.”

The server then transmits this prompt sentence to a generative AI model that is stored and executed on the server. In one embodiment, the generative AI model comprises a transformer-based neural network having an encoder-decoder or decoder-only structure with multiple attention layers, feed-forward layers, and layer normalization components. The server initializes the model with parameters that have been trained on a large corpus of natural-language data using a next-token prediction objective. During training, the server performs mini-batch gradient descent on the model parameters using an optimization algorithm such as Adam. The server minimizes a cross-entropy loss between predicted token distributions and ground-truth tokens. The server may apply data augmentation methods such as paraphrasing of training sentences, random masking, and noise injection to improve robustness.

At inference time, the server feeds the prompt sentence into the generative AI model as a token sequence. The server sets decoding parameters such as a maximum output length, a temperature, and a top-k or nucleus sampling threshold to encourage concise and deterministic guidance. The server thereby obtains a natural-language guidance text that describes recommended actions and important environmental features.

The server executes a verification module that evaluates the generated guidance text according to predetermined safety criteria and formatting constraints. The server parses the guidance text into tokens and checks for prohibited terms, ambiguous references (for example, references such as “over there” without a clear direction), and conflicting actions (for example, “do not move” and “walk forward” in the same instruction). The server also verifies that the length of the guidance text does not exceed a configured token or character limit. If one or more checks fail, the server either applies a deterministic rewriting rule set (for example, replacing ambiguous expressions with directional words such as “left” or “right”) or generates a secondary prompt sentence that instructs the generative AI model to revise the text under stronger constraints. The server then adopts the verified and, if necessary, corrected guidance text.

The server converts the verified guidance text into audio by invoking a text-to-speech engine. The server may employ a neural text-to-speech model that maps phoneme or character sequences to mel-spectrograms and then to waveforms. The server selects a voice characteristic and speaking rate that match user preferences. The server encodes the resulting waveform with an audio codec and transmits the audio data to the terminal over the secure communication session. The server may insert metadata such as message priority and validity duration.

The terminal receives the audio data and outputs it through the bone-conduction acoustic output device. The terminal may execute a local audio mixer that applies dynamic range compression, equalization, and volume control based on ambient noise level measured by the microphone. The terminal thereby presents clear guidance while maintaining situational awareness.

The user listens to the guidance and moves in response. The user can also issue an utterance audio request. The terminal captures the utterance audio through the microphone and performs basic pre-processing such as echo cancellation and noise suppression using a digital signal processing library. The terminal encodes the pre-processed audio and transmits it to the server.

The server performs speech recognition processing on the received utterance audio using an automatic speech recognition model. In one embodiment, the server uses an encoder-decoder neural network with convolutional front-ends and recurrent or transformer layers. The server converts the audio into spectrogram features and feeds them into the model, obtaining a sequence of characters or words with associated probabilities. The server applies beam search decoding and language-model scoring to generate a transcription of the utterance.

The server then performs intent analysis processing by applying a natural-language understanding model to the transcription. The server encodes the transcription using a sentence embedding model and classifies the embedding into one of multiple intent categories (for example, navigation request, information request, menu reading request) using a classifier. The server also extracts entities such as location names, object identifiers, or service types.

When the intent corresponds to a navigation request, the server accesses a map database through a route information acquisition function and retrieves route information from a current position to a destination. The server may obtain the current position from the terminal or from a location service. The server merges this route information with the structured scene information so that route guidance aligns with current obstacles and landmarks. The server then constructs a dialogue-oriented prompt sentence, such as:

“User question: ‘Where is the next bus stop?’ Context: user is walking along a street; current position is [coordinates]; nearest bus stop is 120 meters ahead on the right; sidewalks are clear. The user is visually impaired and prefers very short, direct answers. In one short sentence, tell the user where the next bus stop is and how to reach it.”

The server inputs the dialogue-oriented prompt sentence to the generative AI model. The server obtains a response text, for example: “The next bus stop is about 120 meters ahead on your right; keep walking straight and it will be on the corner.” The server verifies this response text against consistency rules and formatting constraints similar to those described above and then converts the verified response text into audio using the text-to-speech engine.

The server transmits the audio to the terminal for prioritized output. The terminal may temporarily lower or pause non-critical messages to output navigation-related guidance with higher priority.

The server maintains dialogue history information and behavior history information in one or more databases. The server records, for example, which guidance messages were delivered, what actions the user took afterward as inferred from subsequent scene changes or location data, which queries were submitted, and how frequently the user requested more detail. The server executes a personalization model that adjusts control parameters such as the detail level, the threshold for announcing certain object types, and the preferred sentence structure. The personalization model may use a reinforcement-learning or multi-armed bandit algorithm to select parameter updates that maximize a utility function reflecting reduced interruption rate, reduced repeated announcements, and improved user compliance with safety instructions. The server then applies updated parameters to subsequent scene interpretation and prompt-generation operations.

This architecture produces several technical effects. First, the transformation of raw image data into structured scene information and then into scene interpretation information reduces communication and processing load by filtering and summarizing information before invoking the generative AI model. Instead of transmitting or processing all detected entities at full resolution, the system encodes only high-priority entities in compact form. This reduces data volume, shortens prompt sentences, and enables shorter inference time in the generative AI model. Second, the use of separate discrimination-use learned models optimized for low-latency detection and recognition allows the system to offload high-dimensional pattern recognition from the generative model, which improves overall computational efficiency and allows the generative model to focus on language composition. Third, the verification and feedback loop that programmatically constrains generative outputs yields more predictable and safer guidance than free-form text generation, without requiring human curation. This loop reduces the need for repeated regeneration of messages and minimizes the risk of unsafe instructions.

Furthermore, because the server integrates dialogue processing with scene interpretation, the server can reuse existing structured scene information in response to user queries, avoiding redundant sensing and analysis. For example, when the user asks about the price of an item visible in the scene, the server can directly reference already computed text recognition results instead of performing a new recognition pass. This reduces processing load, lowers latency, and improves power consumption efficiency on both the terminal and the server.

The system does not simply automate human descriptive tasks; rather, the system implements non-conventional data structures and algorithmic flows that leverage machine-learned models and prompt-engineering techniques to optimize internal computer operations. By controlling how recognition outputs are structured, filtered, and encoded into prompt sentences, and by adjusting these processes based on logged behavior data, the system improves processing speed, recognition stability, and communication efficiency in comparison to conventional architectures that either send raw data to a generative model or use fixed, non-adaptive prompts. The causal relationship between the described modules and the resulting technical improvements is thus established: structured scene information and scene interpretation information reduce data complexity; optimized prompt sentences reduce generative model computation; verification and personalization reduce redundant outputs and reprocessing; and integrated dialogue and perception pipelines eliminate duplicative analysis. As a result, the server and terminal cooperate to provide timely, accurate, and resource-efficient audio guidance that is tightly coupled to control of physical devices such as cameras, microphones, communication interfaces, and bone-conduction output devices.

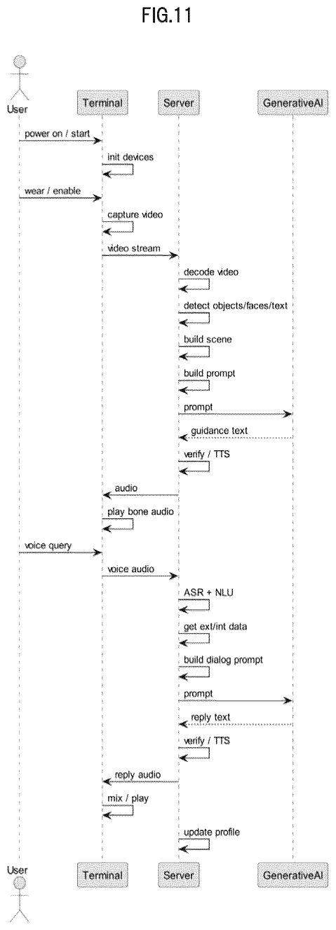

The following describes the processing flow using FIG. 11.

### Step 1:

The terminal initializes hardware components and user profile.

The terminal receives a power-on event (input) and loads configuration data such as camera parameters, audio volume, language settings, and network credentials from local non-volatile storage (input). The terminal uses its local processor to initialize device drivers for the imaging device, microphone, wireless communication module, and bone-conduction acoustic output device, and it allocates memory buffers for image frames and audio data (processing). The terminal outputs an initialized runtime state in which all peripherals are ready for capturing environment image data and user utterance audio (output).

### Step 2:

The user activates assistive operation.

The user presses a physical button or pronounces a wake word (input). The terminal detects this activation event through a hardware interrupt or a keyword-spotting module (processing). The terminal then outputs a control signal that starts continuous environment capture, enables low-latency communication with the server, and sets an internal mode flag indicating that assistive guidance is active (output).

### Step 3:

The terminal captures environment image data.

The terminal uses the imaging device to acquire raw image frames (input) at a configured frame rate and resolution. The terminal applies image processing in an image signal processor, including automatic exposure, white-balance correction, noise reduction, and image stabilization (processing). The terminal tags each frame with a timestamp and orientation data from an inertial sensor, and stores the resulting processed frame as environment image data in a frame buffer (output).

### Step 4:

The terminal compresses image frames and prepares transmission packets.

The terminal reads environment image data from the frame buffer (input) and passes the data to a hardware video encoder. The terminal performs data processing by converting raw pixel data into a compressed video bitstream using a video compression standard, adjusting bitrate and keyframe interval based on current network quality (processing). The terminal segments the bitstream into network packets, attaches sequence numbers and timestamps, and produces a sequence of transmission packets ready to be sent to the server (output).

### Step 5:

The terminal transmits environment image data to the server and receives audio data.

The terminal takes the sequence of transmission packets (input) and uses a wireless communication interface to send them over an encrypted session to the server. The terminal manages data processing by implementing congestion control and adaptive bitrate, based on measured round-trip time and packet loss (processing). The terminal simultaneously receives incoming audio packets from the server (input) and stores them in an audio buffer for later playback (output).

### Step 6:

The server receives and decodes transmitted video packets.

The server accepts the incoming connection and obtains video packets from the terminal (input). The server reorders packets using sequence numbers, checks integrity, and reconstructs the compressed video stream (processing). The server decodes the compressed stream using a multimedia library, thereby converting compressed data into raw image frames with associated timestamps and metadata, and stores them as environment image data for analysis (output).

### Step 7:

The server pre-processes frames for discrimination-use learned models.

The server takes the raw environment image data (input) and resizes each frame to model-specific input dimensions, converts color format, and normalizes pixel values (processing). The server batches consecutive frames into tensors and transfers them to graphics processing unit memory, outputting pre-processed frame tensors suitable for object recognition, face recognition, and character recognition models (output).

### Step 8:

The server executes object recognition processing and estimates distances.

The server inputs the pre-processed frame tensors (input) into an object detection neural network. The server performs data processing by computing convolution, activation, and attention operations across layers of the network to generate feature maps, bounding boxes, class scores, and confidence scores (processing). The server applies non-maximum suppression and uses camera parameters and bounding box sizes to estimate distances to objects, thereby outputting a list of recognized objects with types, positions, distances, and confidence values (output).

### Step 9:

The server performs person face recognition.

The server reads the same pre-processed frame tensors (input) and sends them to a face detection model to obtain candidate face regions. The server crops those regions and passes them to a face embedding model, which applies convolutional and fully connected layers to produce face embedding vectors (processing). The server compares these vectors with stored reference embeddings using distance calculations, identifies matches exceeding a similarity threshold, and outputs a list of recognized persons with identity labels, positions, and match confidences (output).

### Step 10:

The server performs character recognition processing for text in the scene.

The server uses the pre-processed frames (input) and executes a text detection model to locate text regions. The server rectifies and normalizes each region and feeds the normalized regions into an optical character recognition model that computes feature sequences and decodes them into character strings (processing). The server groups characters into words and lines, assigns language tags, and outputs recognized text elements each with content, bounding region, and confidence scores (output).

### Step 11:

The server generates structured scene information.

The server takes as input the lists of recognized objects, recognized persons, and recognized text elements (input). The server performs data processing by constructing a structured data object that includes entries for each entity with standardized attributes such as type, position, distance, confidence, and timestamp, and linking entities across frames using tracking logic (processing). The server outputs structured scene information representing the current environment in a compact and machine-readable form (output).

### Step 12:

The server produces scene interpretation information based on user attributes.

The server retrieves the structured scene information and user attribute information such as preferred language and safety sensitivity level (input). The server computes importance scores for each entity using rules based on entity type, distance, motion, and recent announcement history, and filters out low-importance or redundant entities (processing). The server outputs scene interpretation information that includes only selected high-priority entities and global scene summaries intended for subsequent guidance generation (output).

### Step 13:

The server constructs a prompt sentence for the generative AI model.

The server takes the scene interpretation information and dialogue history information (input) and executes a prompt-generation algorithm. The server performs data processing by mapping structured entries (for example, “stairs ahead at 5 m”) into descriptive phrases and concatenating them with explicit control instructions regarding style and length (processing). The server outputs a text-format prompt sentence, such as “You are assisting a visually impaired user. Current scene: a crosswalk is 4 meters ahead; the pedestrian signal is green; one car is stopped 10 meters away. In at most two short sentences, tell the user what to do next, focusing on safety.” (output).

### Step 14:

The server invokes the generative AI model to generate guidance text.

The server receives the prompt sentence (input) and tokenizes it according to the vocabulary of a transformer-based language model. The server processes the tokens through multiple attention and feed-forward layers to compute output token probabilities and performs constrained decoding to generate a natural-language guidance text with limited length (processing). The server outputs a guidance text string that provides recommended actions and highlights critical environmental information (output).

### Step 15:

The server verifies and, if necessary, adjusts the guidance text.

The server takes the generated guidance text and predefined safety and formatting rules (input). The server parses the text and executes rule checks to detect ambiguous expressions, conflicting instructions, or excessive length (processing). If a violation is found, the server applies deterministic text modifications or issues a refinement prompt to the generative model, then selects a corrected version. The server outputs a verified guidance text that conforms to safety and format constraints (output).

### Step 16:

The server converts guidance text into audio data and transmits it.

The server uses the verified guidance text (input) and calls a text-to-speech module that converts characters or phonemes into audio waveform samples using neural synthesis (processing). The server encodes the waveform into compressed audio packets and attaches metadata such as message priority and validity duration, then sends the audio packets through the secure communication channel to the terminal (output).

### Step 17:

The terminal outputs guidance audio through bone-conduction speakers.

The terminal receives audio packets from the server (input) and decodes them into waveform data. The terminal performs audio processing such as volume adjustment, equalization, and dynamic range compression based on the user's audio profile and detected ambient noise level (processing). The terminal delivers the processed waveform to the bone-conduction transducers, thereby outputting guidance audio that physically vibrates the user's skull and is perceived as sound (output).

### Step 18:

The user moves and optionally issues a voice query.

The user listens to the guidance audio and changes direction, speed, or actions accordingly (output in the real world). The user may then utter a question such as “Where is the next bus stop?” or “Read this menu” (input). The terminal captures this utterance as audio data using the microphone and stores it in an audio buffer for further processing (output).

### Step 19:

The terminal pre-processes and transmits utterance audio.

The terminal takes the buffered utterance audio (input) and applies noise suppression, echo cancellation, and level normalization using a digital signal processing library (processing). The terminal then encodes the cleaned audio into a compressed format and sends the encoded packets over the secure communication session to the server, outputting a transmission stream representing the user's speech (output).

### Step 20:

The server performs speech recognition and intent analysis.

The server receives the compressed utterance audio stream (input) and decodes it into waveform samples. The server computes acoustic features such as spectrograms or mel-filterbank coefficients and passes them into an automatic speech recognition model that outputs a sequence of characters or words (processing). The server then inputs the transcription into a natural-language understanding model that classifies the utterance into an intent category and extracts relevant entities, thereby outputting a structured representation of user intent and parameters (output).

### Step 21:

The server acquires related external or internal information.

The server uses the structured intent representation and user context (input) to determine what data is needed, such as route information, nearby facility information, or item details. The server performs data processing by querying external services via application programming interfaces and by consulting internal databases for stored user preferences or previously recognized text (processing). The server outputs combined information describing, for example, the location of a nearest bus stop, the content of a menu, or the price of a particular product (output).

### Step 22:

The server generates a dialogue-oriented prompt sentence and response text.

The server takes the intent, combined external/internal information, and current structured scene information (input) and assembles a dialogue-oriented prompt sentence that includes the user's question and relevant context, along with instructions about answer style and brevity (processing). The server outputs a prompt sentence such as “User question: ‘Where is the next bus stop?’ Context: nearest bus stop is 120 meters ahead on the right; sidewalks are clear. In one short sentence, tell the user where the next bus stop is and how to reach it.” (output). The server then inputs this prompt sentence to the generative AI model (input), performs token-based inference as in earlier steps, and generates a response text that directly addresses the user's query (processing and output).

### Step 23:

The server verifies the response text, converts it to audio, and sends it.

The server receives the response text and applies the same safety and formatting verification rules as used for guidance text (input and processing). The server outputs a verified response text that is concise and unambiguous (output). The server then converts the verified response text into audio using the text-to-speech module and transmits the encoded audio packets to the terminal via the secure channel (processing and output).

### Step 24:

The terminal mixes dialogue audio with ongoing guidance and outputs it.

The terminal receives dialogue audio packets (input) and decodes them to waveform data. The terminal reads any currently playing guidance audio from an audio buffer (input) and performs mixing logic that attenuates or pauses low-priority audio when a high-priority navigation or safety message is present (processing). The terminal outputs the combined audio stream through the bone-conduction device so that the user hears both safety guidance and answers to queries in a prioritized manner (output).

### Step 25:

The server updates personalization parameters based on behavior and dialogue history.

The server collects logs of scene interpretation results, delivered messages, user queries, and inferred user reactions such as frequent repetition requests or ignored messages (input). The server performs data processing by computing statistics and running a personalization algorithm that adjusts control parameters including detail level, announcement thresholds, and preferred phrasing patterns (processing). The server outputs updated user-specific control parameters and stores them in a profile database, so that subsequent scene interpretation and prompt sentence generation reflect the user's observed behavior and preferences (output).

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional assistive systems for visually impaired users typically rely on fixed, rule-based processing pipelines running on general-purpose computing platforms. Such systems often separate low-level perception (for example, object detection) from high-level guidance generation (for example, spoken instructions) without an integrated control architecture that adapts computation to the actual environment and user state. As a result, existing systems tend to either over-generate information, causing cognitive overload, or under-generate critical warnings, compromising safety. Moreover, many systems simply “apply AI” as a black box, without explicit control over how generative models are prompted or how generated outputs are validated against sensor data, which can lead to instructions that are inconsistent with the real environment.

In typical client-server architectures for assistive applications, terminal devices capture image data and send it to a server, where analysis is performed. However, known architectures do not explicitly structure the processing pipeline around machine-executable scene description information and do not tightly couple that scene description with the control of a generative AI model via dynamically constructed prompt sentences. The absence of such an intermediate representation often makes it difficult to systematically constrain and validate generative outputs, and to update the guidance logic in response to ongoing user interaction. This leads to inefficiencies in how computing resources are used, difficulty in debugging or auditing the behavior of AI components, and an increased risk of generating navigation commands that are incomplete, ambiguous, or unsafe.

In addition, existing voice-interactive systems usually treat user queries (for example, schedule inquiries or visitor inquiries) and environment-aware navigation guidance as independent functions. This separation prevents the underlying computing system from reusing a unified scene description and prompt-generation mechanism across both environment-driven and user-driven interactions. As a consequence, the system may maintain multiple redundant data flows, speech interfaces, and logic layers, which increases complexity, latency, and potential failure points. Such architectures also make it difficult to implement consistent safety checks over all AI-generated text, regardless of whether it originates from an environment-triggered prompt or a user-triggered prompt.

Furthermore, prior systems frequently do not formalize the way they adapt prompt sentences for generative AI models based on obstacle positions, relative distances, user attributes, and external information sources (for example, schedules or visitor lists). Without a clear computational mechanism for generating, constraining, and regenerating prompt sentences as first-class data objects, the system cannot reliably enforce that generative AI outputs remain aligned with sensor-derived facts or user-specific safety policies. This limits the ability of system designers to improve the underlying computer technology-namely, the way processors orchestrate perception, prompt construction, model invocation, and post-generation validation in a real-time, closed-loop manner.

Accordingly, there is a need for a computer-implemented system that improves the way processors in a distributed architecture (including terminal devices and servers) (i) transform raw sensor streams into structured scene description information, (ii) construct and adapt prompt sentences for a generative AI model according to that scene description and user attributes, (iii) validate generated guidance text against the scene description, and (iv) update the internal representations and prompts based on user voice instructions. By improving these underlying computational mechanisms, the system can provide more reliable, safe, and efficient environment-aware audio guidance and conversational responses for visually impaired users, while simultaneously improving the transparency and controllability of the AI processing pipeline from a computer-technology perspective.

The specific processing by the specific processing unit 290 of the data processing device 12 in Application Example 1 is realized by the following means.

The present invention provides a server comprising a processor configured to receive time-series image information and associated distance information from a terminal device, to generate structured scene description information including object, person, and character information with corresponding position and relative distance information, and to store user attribute information in association with a user identifier; the processor further configured to dynamically construct, based on the scene description information and the user attribute information, a prompt sentence to be input to a generative AI model, the prompt sentence including constraint information that specifies a response style, a content scope, and safety-related requirements; the processor further configured to supply the prompt sentence to the generative AI model, to obtain audio guidance text information generated by the generative AI model, and to validate the audio guidance text information against the scene description information by checking whether the generated text is consistent with detected obstacles, directions, and distances; the processor further configured, when inconsistency or incompleteness is detected, to modify the constraint information in the prompt sentence and to request regeneration from the generative AI model until a validated audio guidance text information is obtained; the processor further configured to generate response scene description information and corresponding prompt sentences based on user instruction information derived from user utterances indicating schedule information inquiries or visitor information inquiries, and to obtain response audio guidance text information from the generative AI model based on external or internal data sources; and the processor further configured to transmit validated audio guidance text information to the terminal device for conversion into audio signals output via an acoustic output apparatus, while controlling communication so that at least the time-series image information, the scene description information, and the audio guidance text information are encrypted during transmission between the terminal device and the server. This enables an improved computer-implemented architecture in which the processor orchestrates perception, prompt construction, generative inference, and safety validation as explicit computational steps, thereby enhancing reliability, safety, and efficiency of environment-aware and conversational audio guidance for visually impaired users while improving the technical functioning of the underlying information processing system.

The term “system” refers to a combination of one or more information processing devices, one or more terminal devices, and associated hardware and software components that collectively implement the claimed functions.

The term “processor” refers to any hardware element or combination of hardware elements configured to execute instructions, including but not limited to a central processing unit, a graphics processing unit, a digital signal processor, a microcontroller, or a programmable logic device, and may represent a single processor or multiple processors operating together.

The term “terminal device” refers to a user-side electronic apparatus that includes at least an imaging apparatus, an acoustic input apparatus, and an acoustic output apparatus, and that communicates with an information processing device over a communication network.

The term “information processing device” refers to a server-side or cloud-side electronic apparatus that includes at least the processor configured to perform analysis of sensor data, generation of scene description information, construction of prompt sentences, interaction with a generative AI model, and generation of audio guidance text information.

The term “imaging apparatus” refers to any image sensing hardware configured to capture optical information of an environment, including but not limited to a camera module, an image sensor, a lens, and associated control circuitry.

The term “time-series image information” refers to a sequence of image frames, video data, or other temporally ordered visual data obtained from the imaging apparatus.

The term “distance information acquisition apparatus” refers to any hardware configured to obtain distance or depth information relative to objects in the environment, including but not limited to infrared sensors, time-of-flight sensors, stereo cameras, or other range-finding devices.

The term “distance information” refers to data indicating an estimated physical distance or depth between the imaging apparatus and one or more objects or regions in the environment.

The term “processing apparatus” refers to any computational hardware, which may be part of or separate from the processor, configured to execute algorithms for recognizing objects, persons, and character information and for generating scene description information.

The term “scene description information” refers to structured data that represents a state of an environment, including at least information about objects, persons, and character information detected in time-series image information, together with associated position information, relative distance information, and optionally contextual information such as location or time.

The term “object” refers to any physical item present in the environment that can be detected in image or distance information, including but not limited to furniture, appliances, obstacles, and architectural elements.

The term “person” refers to a human individual detected in image or distance information, and may further include identification information such as a name or role when such information is available.

The term “character information” refers to text or symbol data obtained from image information using character recognition or optical character recognition techniques.

The term “position information” refers to data indicating a spatial relationship of an object, person, or character information relative to the imaging apparatus or user, including but not limited to direction, orientation, and coordinates.

The term “relative distance information” refers to data indicating a distance or range value between the imaging apparatus or user and an object, person, or character information, expressed in absolute or normalized units.

The term “user attribute information” refers to data associated with a specific user, including but not limited to language preference, age group, mobility characteristics, cognitive characteristics, schedule information, and configuration parameters for guidance.

The term “prompt sentence” refers to a natural-language or structured text string generated by the processor and supplied as input to a generative AI model, the text string encoding at least part of the scene description information, user attribute information, and constraint information specifying how the generative AI model should respond.

The term “constraint information” refers to data embedded in or associated with a prompt sentence that specifies requirements on the behavior or output of the generative AI model, including but not limited to length restrictions, tone, safety conditions, content scope, and mandatory inclusion or exclusion of particular elements.

The term “generative AI model” refers to a machine-learned model, such as a generative language model based on a neural network, that is configured to receive a prompt sentence as input and to generate text output, including audio guidance text information or response audio guidance text information.

The term “audio guidance text information” refers to text data generated by the generative AI model and intended to be converted into speech for providing environment-related guidance, instructions, or notifications to a user.

The term “response audio guidance text information” refers to text data generated by the generative AI model in response to user instruction information, such as schedule information inquiries or visitor information inquiries, and intended to be converted into speech.

The term “speech synthesis apparatus” refers to hardware and software components configured to convert text information into audio signals, including but not limited to text-to-speech engines and associated signal processing components.

The term “audio signal” refers to an electrical or digital representation of sound that is suitable for driving an acoustic output apparatus.

The term “acoustic output apparatus” refers to any device configured to present audio signals to a user, including but not limited to a bone-conduction transducer, an earphone, or a loudspeaker.

The term “bone-conduction type acoustic output apparatus” refers to an acoustic output apparatus that transmits sound vibrations through bones of the user's head, rather than primarily through air conduction to the eardrum.

The term “acoustic input apparatus” refers to any device configured to obtain sound from the environment, including but not limited to microphones and associated signal conditioning circuitry.

The term “utterance sound” refers to audio data representative of speech produced by the user and captured by the acoustic input apparatus.

The term “user instruction information” refers to data derived from the utterance sound of the user that indicates a command, query, or preference, including but not limited to schedule information inquiries and visitor information inquiries.

The term “schedule information” refers to data describing planned events, appointments, reminders, or time-based tasks associated with a user.

The term “visitor information” refers to data describing persons scheduled or detected as visitors to the user, including but not limited to identifiers, roles, and expected visit times.

The term “response scene description information” refers to structured data generated in response to user instruction information, the data including at least information obtained from external or internal data sources and used as context for generating response audio guidance text information.

The term “communication apparatus” refers to any hardware and software components configured to transmit and receive data over a communication network between the terminal device and the information processing device.

The term “communication network” refers to any wired or wireless data network, including but not limited to cellular networks, wireless local area networks, and wide area networks.

The term “encrypt” refers to applying a cryptographic transformation to data such that the data is rendered unreadable to unauthorized entities and can only be restored to its original form using appropriate decryption keys or procedures.

The term “external information source” refers to any data storage or service outside the information processing device that provides information such as schedule information or visitor information, including network-based services and remote databases.

The term “internal storage device” refers to any non-transitory storage medium within or directly associated with the information processing device, including but not limited to semiconductor memory and magnetic or optical storage, used to store data such as user attribute information, schedule information, or visitor information.

In one embodiment, a system for supporting independent living of a visually impaired user includes a terminal, a server, and a communication network connecting the terminal and the server. The terminal includes at least an imaging apparatus, an acoustic input apparatus, and an acoustic output apparatus. The server includes at least a processor, a storage device, and a network interface. The processor executes one or more programs stored in the storage device to implement the functions described below.

The terminal captures surrounding environment information using a camera module as the imaging apparatus. The terminal includes a high-resolution image sensor, such as a solid-state image sensor, a wide-angle lens, and an image signal processor implemented on a mobile system-on-chip. The terminal combines this imaging apparatus with a distance information acquisition apparatus, such as an infrared sensor, a time-of-flight sensor, or a stereo camera pair, to obtain distance information corresponding to objects in the field of view. The terminal generates time-series image information by acquiring successive frames from the image sensor and by associating each frame with a timestamp and, when available, a depth map derived from the distance information acquisition apparatus.

The server receives the time-series image information and distance information from the terminal and stores the received data temporarily in a memory. The server executes a processing program that uses a deep neural network to recognize objects, persons, and character information in the image frames. The server, for example, uses a convolutional neural network-based object detector that includes multiple convolutional layers, batch normalization layers, and non-linear activation functions, followed by one or more fully connected layers. The server uses bounding box regression and classification heads to output object class scores and bounding box coordinates. The server computes a loss function such as a combination of cross-entropy loss for classification and mean squared error or IoU-based loss for bounding box regression during training, and the server updates the parameters of the neural network with a gradient-based optimization algorithm, such as stochastic gradient descent with momentum or an adaptive method.

The server uses a separate neural network for face recognition, which extracts feature vectors from face regions. The server uses a metric-learning-based embedding model trained with a loss function such as a triplet loss or a margin-based softmax loss to arrange similar faces close to each other in an embedding space. The server compares a feature vector of a detected face with stored feature vectors in the storage device using a similarity measure, such as cosine similarity, and the server determines a person identity when the similarity exceeds a predetermined threshold.

The server performs character recognition by applying a text detection network to the image frames to locate text regions and by applying an optical character recognition engine to those regions. The server, for example, uses a convolutional-recurrent neural network architecture for recognizing sequences of characters. The server extracts features along the width of the text region and feeds these features to a recurrent network, such as a bidirectional long short-term memory network, which outputs character probabilities over a vocabulary. The server decodes the probabilities with a beam search or a greedy decoding process to obtain character information.

The server generates scene description information by organizing the recognition results into a structured representation. The server, for example, associates each detected object with position information derived from its bounding box location and the camera intrinsic parameters, and with relative distance information derived from depth values of the distance information acquisition apparatus or from a monocular depth estimation network. The server represents direction as one of a finite set of categories such as “front,” “front-left,” “left,” “front-right,” and “right,” and the server derives these categories from the horizontal position of the object in the image. The server associates each person detected with an optional identity label derived from face recognition and with position and distance information. The server associates each character information item with the region in the environment from which it was read.

The server stores user attribute information in the storage device. The server maintains, for each user, fields such as a preferred language, an age group, a mobility profile, a desired verbosity level for guidance, and schedule information and visitor information. The server may store schedule information in a relational database table with attributes including a time field, an event description field, and an event category field. The server may store visitor information in another table with attributes including a visitor identifier, a person role field, and planned visit times.

The server generates a prompt sentence to be supplied to a generative AI model. The server constructs the prompt sentence by combining at least a part of the scene description information and the user attribute information. The server inserts explicit constraint information into the prompt sentence so that the generative AI model is instructed to generate text in a desired format. The server uses, for example, a prompt of the following form:

“You are an assistive guidance system for a visually impaired elderly user.

The scene description is: sofa in front at 1.5 meters, clear space on the left.

The user prefers short, direct instructions in English.

Generate one short spoken guidance sentence warning the user about the sofa and indicating a safe direction to move.”

The server may also generate prompt sentences for other contexts, for example:

“You are an assistive AI for a visually impaired user in a home environment.

Scene description: Location: kitchen. Objects: refrigerator on the right at 1.2 meters, medicine shelf in front at 0.8 meters. Text detected: ‘Blood pressure medicine—red bottle—12:00’. Current time: 12:00.

Generate one short spoken sentence reminding the user to take the correct medicine, including the color of the bottle and where it is located.”

The server supplies the prompt sentence to the generative AI model. The server implements the generative AI model as a transformer-based language model that includes a stack of self-attention layers and feedforward layers. The server trains the generative AI model on large text corpora with an autoregressive objective, in which the model predicts each token in a sequence given the previous tokens. The server uses a loss function such as the negative log-likelihood of the training tokens and updates the model parameters using a gradient-based optimizer. The server optionally fine-tunes the model on domain-specific dialogue and guidance text so that the model produces outputs suitable for visually impaired users.

The server configures the generative AI model at inference time with parameters such as a temperature parameter that controls randomness, a maximum token count, and possibly a top-k or top-p sampling scheme. The server receives an output sequence of tokens representing audio guidance text information from the generative AI model. The server then validates the audio guidance text information against the scene description information. The server, for example, parses the generated text to detect mentioned objects and direction expressions and checks whether the mentioned objects exist in the scene description and whether the direction expressions are consistent with the position information and relative distance information. The server rejects output that mentions an object not present in the scene description or that instructs the user to move toward a detected obstacle. When the server detects inconsistency or incompleteness, the server modifies the constraint information in the prompt sentence, for example by stating “Do not mention any object that is not listed in the scene description,” and requests regeneration from the generative AI model.

The server stores the validated audio guidance text information and transmits it to the terminal. The server may also store, for audit or improvement purposes, the prompt sentence, the scene description information, and the final accepted output.

The terminal receives the audio guidance text information and uses a speech synthesis apparatus to convert the text to an audio signal. The terminal may incorporate or access a text-to-speech engine that uses an acoustic model and a vocoder model. The terminal, for example, uses a sequence-to-sequence neural network that maps characters or phonemes to acoustic feature sequences, and a neural vocoder such as a convolutional auto-regressive model to generate waveform samples. The terminal sends the resulting audio signal to a bone-conduction type acoustic output apparatus attached to the frame of a glasses-type device. The terminal controls the volume level based on user attribute information and may adapt the volume based on ambient noise measured by the acoustic input apparatus.

The user hears the audio through the bone-conduction apparatus while still perceiving ambient sounds through air conduction. The user may move according to navigation instructions or act upon reminders. The user may also issue spoken commands. The terminal uses the acoustic input apparatus, for example one or more microphones and an audio front-end processor, to collect utterance sound produced by the user. The terminal performs signal processing such as echo cancellation, noise suppression, and voice activity detection to isolate the utterance sound from background noise and from the terminal's own audio output.

The terminal transmits the processed audio data or recognized text of the utterance sound to the server. The server may implement an automatic speech recognition model, such as an encoder-decoder neural network with attention or a transformer-based model, to convert the utterance sound into text. The server may classify the recognized text to determine whether it corresponds to a schedule information inquiry or a visitor information inquiry. The server, for example, uses a shallow classifier or a neural text classifier to detect intents such as “request_schedule” or “request_next_visitor.”

The server retrieves corresponding schedule information or visitor information from an internal storage device or an external information source. The server then generates response scene description information that includes at least the obtained schedule information or visitor information and uses this to construct a further prompt sentence, for example:

“User question: ‘When is my next visitor coming?’

Data: next visitor is a nurse at 3:00 PM today.

You are an assistive AI speaking to an elderly visually impaired user.

Generate one short spoken answer in English, including the visitor's role and time.”

The server supplies this prompt sentence to the generative AI model and obtains response audio guidance text information. The server may again validate the generated response against the retrieved data, verifying that the time and role mentioned in the response are correct. The server transmits the response audio guidance text information to the terminal for speech synthesis and playback.

The server encrypts data transmitted between the server and the terminal. The server uses, for example, a transport layer security protocol to negotiate encryption keys and to protect confidentiality and integrity of at least the time-series image information, the scene description information, and the audio guidance text information. The server and the terminal may also encrypt data at the application layer, such as encrypting stored face embeddings or user attribute information in the storage device.

This configuration yields multiple technical effects that go beyond mere automation of human tasks. The server defines scene description information as a specific intermediate data structure with explicit position and relative distance information. The server uses this structured representation as the basis for constructing prompt sentences, for constraining generative outputs, and for validating generated text. Because the server operates on explicit scene description information rather than unstructured sensor data, the server reduces computational redundancy, as the same scene representation can be reused for multiple prompts and for multiple guidance outputs. The server improves processing speed and latency by allowing different modules, such as object recognition, face recognition, and generative guidance, to operate asynchronously on the same representation rather than repeatedly scanning raw video.

The server improves accuracy and safety by validating text produced by the generative AI model against sensor-derived facts. The server's validation logic reduces the probability that the system issues instructions that are inconsistent with the physical environment. The server further improves the efficiency of communication by allowing the terminal to send compressed time-series image information and by allowing the server to send only compact text strings back to the terminal, rather than transmitting full audio or video streams from the server to the terminal.

The server's control over the generative AI model via prompt sentence construction and constraint information represents a specific improvement in computer technology. The server uses distinct fields within the prompt sentence to encode scene description information, user attribute information, and safety constraints. The server uses these fields to drive the internal attention mechanisms of the generative AI model toward relevant tokens, and the server filters output based on domain-specific rules. This design allows the generative AI model to be integrated as a controllable component in a larger deterministic pipeline, rather than as a black-box text generator.

The server's deep neural networks for perception and language processing are trained with specific loss functions and data augmentation techniques to optimize for real-time, low-latency operation. The server may use network pruning, quantization, or knowledge distillation to reduce the size and inference time of the models, which results in faster processing and reduced computational load. The server may use a batched inference strategy, where multiple frames or multiple prompts are processed in a single batch, to improve throughput on graphics processing hardware.

In alternative embodiments, the terminal may execute part of the recognition or generative processing. For example, the terminal may run a smaller object detection network locally and send only compressed scene description information to the server. The server may then perform more complex validation and prompt generation. In another embodiment, the generative AI model may be deployed partially on the terminal or on an edge device, with the server providing only constraint information and updated parameters as needed.

In still another embodiment, the system may adjust the structure of prompt sentences depending on bandwidth, latency, or user condition. When network conditions are poor, the server may generate shorter prompts and shorter audio guidance text information to reduce communication load. The system may also vary the degree of detail in guidance depending on the user's mobility profile, thereby controlling both computational complexity and communication overhead.

The interaction between the server, the terminal, and the user, as described above, ensures that environment-aware guidance and conversational responses are produced through an integrated pipeline in which each computational step is explicitly defined and controlled. This design improves the technical functioning of the underlying information processing system by structuring data flows, optimizing model architecture and training, enforcing consistency between sensor data and generated text, and enabling safe and efficient operation in real-world environments.

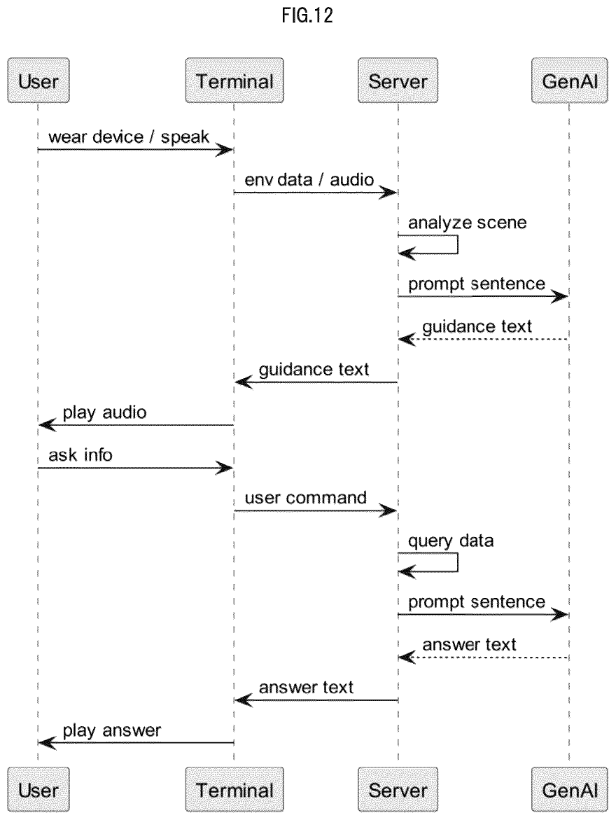

The following describes the processing flow using FIG. 12.

### Step 1:

The terminal acquires surrounding environment data as input, including raw image sensor data and distance sensor data.

The terminal drives the imaging apparatus and the distance information acquisition apparatus, and the terminal samples frames at a predetermined frame rate while associating each frame with a timestamp and a sensor identifier.

The terminal processes the raw image data through an image signal processor, and the terminal performs demosaicing, white balance, noise reduction, and exposure correction to output color image frames.

The terminal fuses the color image frames with distance data from the distance information acquisition apparatus, and the terminal generates time-series image information and corresponding depth maps as output.

### Step 2:

The terminal prepares the time-series image information and depth maps as input for transmission to the server.

The terminal encodes the image frames using a video compression algorithm, and the terminal fragments the compressed data into packets with sequence numbers and timestamps.

The terminal encrypts the packets using a session key negotiated with the server over a secure channel, and the terminal sends the encrypted packets over a communication network.

The terminal outputs an encrypted data stream containing the time-series image information and associated depth information.

### Step 3:

The server receives the encrypted data stream as input from the terminal.

The server decrypts the packets using the corresponding session key, and the server reconstructs the compressed video stream and the associated depth information in correct temporal order.

The server decodes the compressed video stream into individual image frames and aligns each frame with its depth map and timestamp, and the server outputs synchronized frame data ready for analysis.

### Step 4:

The server takes the synchronized frame data and depth maps as input for object and person recognition.

The server applies an object detection neural network to each frame, and the server computes class probabilities and bounding box coordinates for candidate objects.

The server combines bounding box pixel coordinates with depth values and camera calibration parameters, and the server calculates position information and relative distance information for each detected object.

The server outputs a set of object annotations including object types, positions, and distances for each frame.

### Step 5:

The server uses the synchronized frame data as input for person and face recognition.

The server detects human faces in the frames using a face detection network, and the server extracts face regions as cropped images.

The server feeds each cropped face image into a face embedding model, and the server calculates feature vectors representing the faces in an embedding space.

The server compares each feature vector with stored feature vectors in a database by computing similarity scores, and the server outputs person identity annotations when the similarity exceeds a threshold, or unknown person annotations otherwise.

### Step 6:

The server uses the synchronized frame data as input for character information recognition.

The server detects text regions in each frame with a text detection model, and the server crops the detected regions into smaller images.

The server processes each cropped image through an optical character recognition engine, and the server converts spatial patterns of pixels into sequences of characters.

The server outputs character information items associated with their positions in the frames and with any corresponding depth or distance information.

### Step 7:

The server takes the object annotations, person annotations, and character information items as input for scene description construction.

The server groups the annotations by time window and user context, and the server assigns direction categories to each object and person based on their horizontal positions in the frame.

The server merges position and distance information across consecutive frames to filter out transient detections, and the server maintains only stable entities in the representation.

The server outputs scene description information as a structured dataset containing objects, persons, character information, directions, and relative distances.

### Step 8:

The server takes the scene description information and user attribute information as input to construct a prompt sentence for a generative AI model.

The server retrieves user attribute information such as preferred language, guidance style, and safety preferences from a storage device, and the server selects relevant fields.

The server embeds the scene description information and the user attribute information into a natural-language template, and the server appends constraint information specifying response length, tone, and safety rules.

The server outputs a prompt sentence that encodes the current environment and user preferences in a format suitable for the generative AI model.

### Step 9:

The server uses the prompt sentence as input to the generative AI model.

The server sends the prompt sentence to the generative AI model with inference parameters such as temperature and maximum token count, and the server initiates text generation.

The server receives a sequence of tokens from the generative AI model, and the server concatenates the tokens into audio guidance text information.

The server outputs the audio guidance text information as a candidate guidance message.

### Step 10:

The server takes the candidate audio guidance text information and the scene description information as input for validation.

The server parses the candidate text to detect references to objects, directions, and distances, and the server compares these references with entries in the scene description information.

The server determines whether the candidate guidance includes any instruction that conflicts with detected obstacles or omits required safety information based on predefined rules.

The server outputs either validated audio guidance text information when consistency is confirmed or a validation failure signal when inconsistency or incompleteness is detected.

### Step 11:

The server uses the validation failure signal and the previous prompt sentence as input to refine the prompt.

The server modifies constraint information in the prompt sentence, for example by prohibiting references to non-listed objects or by requiring explicit mention of a safe direction.

The server regenerates a new prompt sentence and resubmits it to the generative AI model, and the server repeats text generation and validation until the server obtains validated audio guidance text information.

The server outputs final validated audio guidance text information for downstream processing.

### Step 12:

The server uses the final validated audio guidance text information as input to a speech synthesis pipeline.

The server may directly pass the text information to a text-to-speech engine or send it to the terminal depending on system configuration.

The terminal receives the audio guidance text information, and the terminal converts the text into an audio signal using a speech synthesis apparatus configured with language and voice parameters.

The terminal outputs the resulting audio signal to a bone-conduction acoustic output apparatus, and the terminal produces audible guidance for the user.

### Step 13:

The user receives the audio guidance as input through the bone-conduction acoustic output apparatus.

The user interprets the guidance, and the user moves or acts according to the instructions, such as changing walking direction or reaching for a specific object.

The user may decide to request additional information or clarification and produces utterance sound as new input to the system.

The user outputs spoken commands or questions that become input for the acoustic input apparatus of the terminal.

### Step 14:

The terminal receives the utterance sound from the user as input through the acoustic input apparatus.

The terminal applies audio preprocessing, including echo cancellation, noise suppression, and voice activity detection, and the terminal segments the utterance from background noise.

The terminal either performs on-device speech recognition to convert the utterance sound into text or forwards the processed audio to the server for recognition.

The terminal outputs recognized user instruction information or a representation of the utterance sound to the server.

### Step 15:

The server uses the user instruction information as input to identify the type of user request.

The server classifies the user instruction as a schedule information inquiry, a visitor information inquiry, or another supported command type using an intent classification algorithm.

The server queries an internal storage device or an external information source based on the classified intent, and the server retrieves corresponding schedule information or visitor information.

The server outputs retrieved data and an updated context suitable for constructing response scene description information.

### Step 16:

The server uses the retrieved data and the current context as input to build response scene description information.

The server encodes the retrieved schedule information or visitor information into a structured representation that includes times, roles, and event descriptions, and the server associates this representation with the user identifier.

The server combines this representation with any relevant current scene description information, such as location or time of day, and the server prepares the combined data for prompt construction.

The server outputs response scene description information representing the content of the answer to the user's inquiry.

### Step 17:

The server uses the response scene description information and the user attribute information as input to construct a response-oriented prompt sentence.

The server embeds the user's original question, the retrieved data, and safety or clarity constraints into a natural-language prompt template tailored for conversational answering.

The server formulates the prompt sentence to require a concise, polite response that includes specific fields such as roles, times, or object descriptions, as appropriate.

The server outputs a prompt sentence that drives the generative AI model to produce response audio guidance text information for the user's inquiry.

### Step 18:

The server uses the response-oriented prompt sentence as input to the generative AI model.

The server performs text generation as in previous steps, and the server obtains response audio guidance text information describing, for example, the user's next visitor or today's schedule.

The server validates the response text against the retrieved schedule information or visitor information to confirm that times and roles match the underlying data.

The server outputs validated response audio guidance text information to the terminal for conversion into an audio signal and playback to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional assistive systems for visually impaired users typically convert sensor inputs into fixed, rule-based voice guidance. In many implementations, a camera or other sensors capture environmental information, a recognition engine applies object or text recognition, and a speech output unit presents pre-defined messages. Such systems generally disregard the user's real-time emotional state and the varying risk level of the surrounding environment. As a result, these systems tend to output either overly detailed explanations even in high-risk situations, or overly sparse and safety-only messages even when the user is relaxed and interested in exploring the surroundings. From a computer-technology perspective, the processing pipeline just maps perception results to static messages, without any dynamic adaptation in the core information-processing architecture.

In addition, emerging generative AI models are capable of producing flexible, natural-language responses, but conventional assistive systems usually employ such models in a generic manner. Specifically, known systems often send simple prompts to a generative AI model without encoding finer-grained machine-interpretable states, such as quantified anxiety, stress, or confusion levels derived from multimodal signals. Therefore, the generative AI model cannot fully leverage rich sensor data and cannot systematically adjust information density, style, or priority based on a formalized state representation. In computer-system terms, the integration between multimodal perception modules and the generative model remains shallow and ad hoc, leading to suboptimal utilization of computation, bandwidth, and model capacity.

Furthermore, conventional architectures typically process camera, audio, and physiological data in separate pipelines, with limited temporal alignment and aggregation. The lack of an integrated sensor data packet and unified emotional state vector leads to inefficiencies and redundant computation on the server side. For instance, emotion or context must be re-inferred or approximated from incomplete subsets of data, which increases latency and reduces robustness. There is also no standardized internal representation, such as a generation prompt sentence that explicitly encodes environment recognition results, emotional tags, and output constraints in a structured, machine-generated natural language form.

Accordingly, there is a need for an improved computer-implemented system and server-side architecture that: (i) aggregates heterogeneous sensor streams into a unified, time-aligned packet; (ii) computes a multimodal emotional state vector and corresponding emotion tag using dedicated estimation models; (iii) automatically constructs a generation prompt sentence for a generative AI model that encodes environment recognition results, emotional state, and context-dependent output constraints; and (iv) dynamically controls the generative AI model so that the resulting guide text is optimized for safety, cognitive load, and user experience. Such a system should improve the internal information-processing pipeline itself, thereby enhancing the technical performance and adaptability of computer-implemented assistive guidance for visually impaired users.

The specific processing by the specific processing unit 290 of the data processing device 12 in Example 2 is realized by the following means.

The present invention provides a server comprising a communication control function configured to receive, from a wearable information terminal, an integrated sensor data packet including image data, acoustic feature data, physiological information data, user identification information, and session information, and to deserialize the integrated sensor data packet into structured data stored in a memory; an environment recognition unit configured to execute, on the image data, environment recognition processing including at least one of object detection processing, person detection processing, and character recognition processing using one or more machine learning models, and to generate environment recognition result data including at least information on obstacles, steps, traffic signal indication states, persons, and character string information existing in a surrounding environment; an emotion estimation unit configured to execute, on the acoustic feature data and the physiological information data, emotion estimation processing using a plurality of estimation models to calculate an emotional state vector having elements representing at least an anxiety level, a stress level, a confusion level, and a relaxation level of a user, and to generate, based on a predetermined decision rule applied to the emotional state vector, an emotion tag indicating at least a high-anxiety state or a relaxed state; a context determination function configured to determine environment context information based on the environment recognition result data and geographical information, the environment context information indicating at least one of an intersection vicinity, a staircase vicinity, a commercial area, and a quiet area; a prompt generation unit configured to construct, in a natural language, a generation prompt sentence to be input to a generative artificial intelligence model, the generation prompt sentence being generated based on the environment recognition result data, the emotional state vector, the emotion tag, the environment context information, a voice command content received from the user, and profile information of the user, and including at least a role instruction to the generative artificial intelligence model, a description of the emotion tag, a summary of the environment recognition result data, and output conditions specifying at least one of a concise imperative style prioritizing safety-related information and a descriptive style including surrounding facility information and recommendation information; and a text generation unit configured to tokenize the generation prompt sentence, input a sequence of tokens representing the generation prompt sentence to the generative artificial intelligence model including a transformer-type language model, perform self-attention computation and sequential token generation to generate guide text for voice guidance or response text for dialogue, apply post-processing including at least one of prohibited-word removal processing, sentence-length adjustment processing, and style conversion processing, and output the post-processed guide text or post-processed response text together with the emotion tag to the wearable information terminal via the communication control function. This enables a computer-implemented assistive system to dynamically adapt the content, style, and information density of generated voice guidance according to a formally computed emotional state, environment recognition results, and context, thereby improving the internal information-processing pipeline, reducing cognitive overload in high-risk situations, enhancing usability and personalization in low-risk situations, and more effectively utilizing generative AI models through structured generation prompt sentences that encode rich multimodal state information.

The term “wearable information terminal” refers to a user-worn computing apparatus, such as a head-mounted or body-mounted device, that includes at least an image acquisition unit, an audio input/output unit, a communication interface, and a processing unit, and that is configured to capture sensor data from a surrounding environment and a user and to communicate the sensor data and received guidance to a server.

The term “image data” refers to digital data representing one or more images or video frames of a physical environment, including pixel values and, in some embodiments, associated metadata such as timestamps and position information.

The term “position information” refers to data indicating a physical location of the wearable information terminal, including, for example, coordinates obtained from a satellite positioning system, a network-based positioning service, or a similar location determination mechanism.

The term “image acquisition unit” refers to hardware configured to capture an image of a physical environment, including at least an optical system and an image sensor, and optionally a control circuit that provides frames to a processing unit.

The term “timestamp” refers to temporal information associated with a data unit, such as a frame or a sensor sample, indicating a time at which the data unit was acquired or generated according to a clock of the wearable information terminal or the server.

The term “acoustic feature data” refers to data derived from a voice signal, including, for example, feature vectors such as spectral coefficients, cepstral coefficients, pitch-related values, and energy values, along with associated utterance interval information.

The term “voice acquisition unit” refers to a functional component configured to obtain a digital representation of a user's voice, to detect speech segments, and to extract acoustic features therefrom, using at least one microphone and signal-processing logic.

The term “voice activity detection” refers to processing that classifies segments of an audio signal into speech and non-speech categories based on acoustic characteristics, thereby identifying utterance intervals.

The term “utterance interval information” refers to data that specifies temporal boundaries of a speech segment in an audio signal, including at least a start time and an end time of the segment.

The term “feature vector” refers to an ordered set of numeric values representing characteristics of a signal or data sample, such as a frame of audio, and used as an input to a machine-learning model or other analytical processing.

The term “physiological information data” refers to time-series data representing physical or physiological states of a user, including, for example, heart activity, skin electrical activity, and body surface temperature, optionally after smoothing or filtering.

The term “biosignal acquisition mechanism” refers to one or more sensors and associated circuitry configured to measure physiological signals from a user, such as heart rate sensors, skin conductance sensors, or temperature sensors, and to output corresponding digital signals.

The term “short-range wireless communication mechanism” refers to a communication interface and protocol stack configured to exchange data over a short distance between devices, such as a wireless personal area network interface.

The term “time-series physiological information” refers to physiological information data organized as a sequence of samples or values indexed by time, enabling analysis of temporal changes in a user's physiological state.

The term “integrated sensor data packet” refers to a structured data unit that aggregates multiple types of sensor data, including at least image data, acoustic feature data, physiological information data, and associated metadata such as user identification information and session information, in a serialized form suitable for network transmission.

The term “user identification information” refers to data that uniquely or pseudonymously identifies a user, such as an identifier assigned in advance by a system, and that is used to associate sensor data and processing results with the user.

The term “session information” refers to data that identifies a logical interaction period or transaction between the wearable information terminal and the server, and that can be used to group multiple communications or data units into a single session.

The term “communication control function” refers to a processing function executed by the server that manages network communication, including receiving and sending data packets, performing serialization and deserialization, and handling communication protocols.

The term “environment recognition unit” refers to a processing component of the server configured to analyze image data using one or more recognition models and to generate structured information describing objects, persons, and text present in the environment.

The term “environment recognition process” refers to processing that analyzes image data to detect and recognize elements in a scene, including at least one of object detection, person detection, and character recognition, and that outputs structured environment recognition result data.

The term “object detection processing” refers to processing that, given an image, identifies regions that correspond to physical objects and outputs properties such as class labels, bounding box coordinates, and confidence scores.

The term “person detection processing” refers to processing that detects the presence and location of human figures or faces in image data and optionally identifies specific persons based on comparison with stored reference data.

The term “character recognition processing” refers to processing that detects regions containing characters or text in an image and converts the visual patterns into corresponding machine-readable character strings.

The term “environment recognition result data” refers to structured data representing a recognized state of the environment, including at least information on obstacles, steps, traffic signal indication states, persons, and character strings, and optionally their positions and distances relative to the user.

The term “obstacle” refers to a physical object or structure in the environment that may impede or affect the movement of a user, such as a barrier, a piece of street furniture, or a moving object.

The term “step” refers to a change in elevation on a surface, such as a curb, stair, or small height difference, that a user may need to be aware of for safe movement.

The term “traffic signal indication state” refers to a status of a traffic signal device, such as a red, yellow, or green indication, that controls or guides pedestrian or vehicle crossing behavior.

The term “emotion estimation unit” refers to a processing component of the server configured to analyze acoustic feature data and physiological information data using one or more models to estimate an emotional state of a user.

The term “emotion estimation process” refers to processing that receives acoustic feature data and physiological information data and outputs an emotional state representation, such as an emotional state vector and an emotion tag, using estimation models and decision rules.

The term “emotional state vector” refers to a multi-dimensional numeric representation of a user's emotional state, having elements that quantify aspects such as anxiety level, stress level, confusion level, and relaxation level.

The term “emotion tag” refers to a discrete label derived from an emotional state vector using a decision rule or thresholding, indicating a categorized emotional state, such as a high-anxiety state or a relaxed state.

The term “high-anxiety state” refers to an emotional condition of a user in which at least one element of the emotional state vector associated with anxiety or stress exceeds a predetermined threshold.

The term “relaxed state” refers to an emotional condition of a user in which elements of the emotional state vector associated with anxiety, stress, and confusion are below respective thresholds, and an element associated with relaxation exceeds a threshold.

The term “decision rule” refers to a predetermined procedure, such as a set of thresholds or logical conditions, applied to an emotional state vector or other numeric values to derive a categorical output, such as an emotion tag.

The term “environment context information” refers to data that classifies or characterizes a contextual situation of the user's environment, such as being in the vicinity of an intersection, a staircase, a commercial area, or a quiet area, based on environment recognition results and geographical information.

The term “intersection vicinity” refers to an area in the physical environment near a crossing of at least two pathways, such as roads or pedestrian paths, where traffic signals or crossing rules may be present.

The term “staircase vicinity” refers to an area in the physical environment near a structure having multiple steps, such as stairs or a stairway, where going up or down may require additional caution.

The term “commercial area” refers to an area in the physical environment characterized by the presence of shops, restaurants, or other commercial facilities, as determined by recognition results or map data

The term “quiet area” refers to an area in the physical environment that is characterized by a relatively low level of activity or noise, such as a park or a residential zone, as inferred from recognition results or environmental data.

The term “prompt generation unit” refers to a processing component of the server configured to automatically construct a generation prompt sentence in a natural language to be input to a generative artificial intelligence model, based on environment recognition result data, emotional state information, context information, and user-related data.

The term “generation prompt sentence” refers to a natural-language text generated by the server and supplied to a generative artificial intelligence model, the text including at least a role instruction, a description of an emotion tag, a summary of environment recognition results, and one or more output conditions controlling the style, content, and information density of a model response.

The term “role instruction” refers to a segment of a generation prompt sentence that defines an intended role or behavior of the generative artificial intelligence model, such as acting as a guide for a visually impaired user.

The term “output condition” refers to information included in a generation prompt sentence that constrains or specifies characteristics of the text to be generated by a generative artificial intelligence model, such as style, length, priority of safety information, or inclusion of facility descriptions.

The term “concise imperative style” refers to a style of generated text in which instructions are expressed using short, direct imperative sentences focusing primarily on necessary actions or warnings.

The term “descriptive style” refers to a style of generated text in which information is expressed using explanatory sentences that may include details about surroundings, facilities, or recommendations in addition to any safety-related content.

The term “generative artificial intelligence model” refers to a machine-learning model configured to generate natural-language text in response to an input prompt, based on learned patterns from training data, and including, for example, a transformer-type language model.

The term “transformer-type language model” refers to a neural-network model for natural-language processing that includes one or more layers of self-attention and feedforward networks and that generates tokens sequentially based on context.

The term “text generation unit” refers to a processing component of the server configured to tokenize a generation prompt sentence, input tokens into a generative artificial intelligence model, execute inference including self-attention and token prediction, and output generated text such as guide text or response text.

The term “guide text” refers to generated natural-language text that is intended to be converted into audio or otherwise presented to a user as guidance about the environment, movement instructions, safety information, or related assistance.

The term “response text” refers to generated natural-language text that is intended to be provided to a user as an answer or reply in an interactive dialogue, based on a user's question or command.

The term “post-processing” refers to processing applied to text generated by a generative artificial intelligence model, including at least one of removing prohibited words, adjusting sentence length, and converting style, in order to satisfy system constraints or quality requirements.

The term “prohibited-word removal processing” refers to post-processing that detects and removes or replaces words or phrases that are disallowed according to a predefined list or policy.

The term “sentence-length adjustment processing” refers to post-processing that shortens or lengthens generated text by splitting, merging, or editing sentences in order to meet length constraints.

The term “style conversion processing” refers to post-processing that modifies the tone or grammatical style of text, such as converting between formal and informal expressions or between descriptive and imperative forms, without changing fundamental semantic content.

The term “auxiliary metadata” refers to additional information transmitted together with generated text, such as emotion tags, context labels, or identifiers, that can be used by the wearable information terminal for output control or logging.

The term “bone-conduction output mechanism” refers to an audio output mechanism that transmits sound vibrations through bones of a user's head rather than through air to the eardrum, thereby allowing the user to perceive both guidance audio and ambient sounds.

The term “surrounding noise level” refers to a measure of ambient sound intensity in a user's environment, derived from audio captured by microphones of the wearable information terminal and used to adjust audio output parameters.

The term “output volume” refers to a parameter controlling the amplitude or loudness of audio signals presented to a user by the wearable information terminal.

The term “frequency characteristic” refers to a parameter or set of parameters describing or controlling how audio output is weighted or filtered across different frequencies, such as by equalization.

The term “noise suppression parameter” refers to a parameter used by a signal-processing algorithm in the wearable information terminal to reduce or attenuate unwanted background noise components in an audio signal.

In the following embodiments, terminal, server, and user cooperate to implement the claimed invention. Each embodiment supports the scope of the claims but does not limit the invention thereto.

### 1. Overall System Configuration

Terminal is a wearable information terminal that a visually impaired user wears on the head or body. Terminal includes at least: an image acquisition unit implemented as a camera module with an optical lens and a solid-state image sensor (for example, a CMOS sensor capable of Full HD or higher resolution); an audio input/output unit including at least one air-conduction microphone, optionally a bone-conduction microphone, and one or more bone-conduction speakers; a physiological information acquisition interface connected either to built-in biosensors or to external wearable sensors over a short-range wireless communication mechanism (for example, a wireless personal area network interface); a processing unit implemented by a mobile-class central processing unit and, optionally, a graphics processing unit; a memory including volatile and non-volatile storage; and a communication interface implementing, for example, wireless local area network or cellular communication. Terminal runs a wearable operating system, such as a mobile-oriented operating system, providing APIs for camera control, audio capture/playback, networking (for example, TCP/IP stack with HTTPS support), Bluetooth communication, and local storage.

Server is an information processing apparatus implemented on one or more server-class computers or virtual machines. Server includes at least one central processing unit, at least one graphics processing unit configured for deep-learning inference and training operations, main memory, persistent storage, and a network interface. Server runs a server-class operating system, such as a Unix-like operating system, and hosts a web application framework implementing REST interfaces, a deep-learning framework (for example, a general deep-learning library), and storage subsystems for models and user data.

User is a visually impaired person who wears terminal during daily activities and provides voice commands and behavioral input to the system.

### 2. Functional Configuration of the Terminal

Terminal captures multimodal sensor data and transmits an integrated sensor data packet to server.

Terminal uses the camera control API of the wearable operating system to configure the image acquisition unit for continuous image capture at a specified frame rate and resolution. Terminal configures parameters such as exposure time, gain, and focus, then requests streaming frames. Terminal associates each captured frame with a timestamp obtained from an internal high-resolution clock and with position information obtained from a location service (for example, a satellite positioning receiver or a network-based location provider). Terminal thereby generates image records and may store them temporarily in a ring buffer. Terminal compresses raw frame data using a multimedia encoding library (for example, a generic H.264/AVC or HEVC encoder) running on the processing unit. Terminal specifies codec parameters such as bit rate, group-of-pictures structure, intra-frame period, and quantization range. Terminal encodes multiple frames into a compressed bitstream, segmenting the bitstream into chunks and maintaining correspondence between chunks and associated timestamps and positions. This reduces the communication load between terminal and server while preserving temporal alignment information. The compression process and explicit association of timestamps and locations provide a technical effect of reduced bandwidth usage without losing the ability to reconstruct a time-aligned environment representation on server.

Terminal acquires audio from the audio input/output unit. Terminal configures the audio driver via an audio hardware abstraction layer to sample audio at a fixed sampling rate, such as 48 kHz, with a fixed bit depth. Terminal segments incoming audio into frames (for example, 20-30 ms windows) and applies a voice activity detection algorithm from a general speech processing library (for example, an energy-based or statistical VAD or a model-based VAD). Terminal classifies each window as speech or non-speech and groups contiguous speech windows to form utterance intervals. Terminal records start and end times of each utterance interval based on the internal clock.

Terminal extracts acoustic feature data from each utterance interval using a feature extraction library (for example, a Mel-frequency cepstral coefficient computation module). Terminal computes, for each short frame within an utterance, at least a set of MFCCs, frame energy, and fundamental frequency (pitch). Terminal organizes these features into sequences of feature vectors, each sequence associated with one utterance interval. This feature-level processing on terminal offloads computation from server, reduces required bandwidth relative to raw audio, and provides stabilized, model-ready features, improving overall latency and throughput of the distributed system.

Terminal gathers physiological signals from biosensors. Terminal either reads sensors directly (for example, via analog-to-digital conversion and sensor drivers) or receives measurements through a short-range wireless interface using a standardized attribute protocol. Terminal periodically obtains heart activity (for example, beats-per-minute or inter-beat interval), skin electrical activity (for example, conductance or resistance), and body surface temperature. Terminal timestamps each sample using the same internal clock used for image and audio data, enabling cross-modal alignment.

Terminal smooths physiological data in real time. Terminal applies digital filters such as moving average filters or low-pass finite impulse response filters with configurable window lengths. Terminal thereby suppresses high-frequency noise due to sensor artifacts or motion. By performing smoothing on terminal, the architecture reduces server-side load and network traffic, provides more stable inputs for emotion estimation, and decreases the variance of estimated emotional state.

Terminal constructs an integrated sensor data packet. Terminal aggregates over a defined time slice multiple image chunks, acoustic feature sequences, and smoothed physiological samples. Terminal also includes user identification information and session information. Terminal maps all pieces into a predefined data structure, such as a message schema defined in a serialization format (for example, a binary structured messaging format). Terminal uses a serializer library to encode this structure into a compact representation suitable for transmission.

Terminal uses an HTTPS client library to transmit the integrated sensor data packet to server. Terminal sets appropriate headers, including content type and authentication tokens. Terminal implements retry logic and queueing mechanisms to handle intermittent connectivity. Terminal thus provides server with time-aligned multimodal sensor streams in an efficient, structured way.

Terminal receives guide text or response text and optional audio data from server. Terminal either invokes a text-to-speech engine provided by the wearable operating system to synthesize audio from received text, or decodes received audio data (for example, using a decoder for a compressed audio format). Terminal then applies user-specific playback parameters, such as volume, equalizer settings, and noise suppression, and outputs guidance audio through the bone-conduction output mechanism. Bone-conduction output enables user to hear environmental sounds simultaneously, improving safety and situational awareness. Terminal may also estimate a surrounding noise level by briefly sampling ambient sound and computing sound pressure level or energy. Terminal then adjusts output volume and frequency characteristics accordingly, improving intelligibility while minimizing unnecessary loudness.

### 3. Functional Configuration of the Server

Server performs environment recognition, emotion estimation, prompt sentence construction, and generative AI-based text generation based on multimodal data.

Server receives integrated sensor data packets via a REST interface. Server uses a web application framework to define an endpoint and to accept HTTPS requests from multiple terminals. Server passes the request body to a deserializer library that converts the byte stream back into structured objects for image data, acoustic feature data, physiological data, user identification information, and session information.

Server decodes image data. If image data is compressed, server uses a general multimedia decoding library to reconstruct frames in a color space suitable for computer vision (for example, RGB). Server associates each frame with its timestamp and position information. Server organizes frames into a time-ordered sequence and may buffer them to allow sliding-window processing.

Server performs environment recognition with a set of trained models. Server loads, from storage, several neural-network models implemented with a deep-learning framework, such as:
An object detection model, which may be a convolutional neural network with multiple stages (for example, backbone, feature pyramid, detection heads) that outputs bounding boxes, class labels, and confidence scores for objects such as pedestrians, vehicles, traffic lights, steps, doors, and obstacles.
A face detection model and a face embedding model, which may be convolutional neural networks producing bounding boxes and high-dimensional feature vectors representing facial identity.
A text detection model that locates text regions in images, possibly using a segmentation-based or anchor-based architecture, and an optical character recognition engine that converts those text regions into character strings.

Server preprocesses frames (for example, resizing, normalization) before feeding them into the neural networks. Server may batch multiple frames to improve GPU utilization. Server computes detection outputs and filters out low-confidence detections. Server then maps pixel coordinates to approximate real-world directions and distances using calibration parameters or geometric assumptions.

Server enriches outputs with specialized post-processing. Server detects traffic lights and classifies their indication state (for example, red, yellow, or green) using either a lightweight classifier applied to cropped regions or an additional small neural network. Server identifies steps by combining object labels and depth or disparity estimation results, calculating distance to the step and height. Server identifies persons associated with stored profiles by computing similarity between face embeddings and a database of reference embeddings, using metrics such as cosine similarity. Server associates recognized text with spatial locations and directions.

Server aggregates recognition outputs into environment recognition result data. Server stores, in a structured representation, for each relevant object or region: object type, location, distance, direction, state (for example, traffic signal indication), recognized text content, and any identification information. This environment recognition result data forms a machine-readable description of the physical surroundings.

### 4. Emotion Estimation and Emotional State Representation

Server estimates a user's emotional state by combining acoustic features and physiological data.

Server loads from storage multiple emotion estimation models implemented using a deep-learning framework and possibly classical statistical models. For acoustic emotion, server may use a recurrent neural network or transformer-based network that accepts sequences of feature vectors (for example, MFCCs and pitch features) and outputs probabilities for emotional categories such as anxiety, stress, calmness, and joy. This network may consist of stacked recurrent layers with attention, or transformer encoder layers followed by a classification head.

Server feeds the acoustic feature sequences for each utterance into the acoustic emotion model and obtains probability distributions over emotion categories. Server may convert these probabilities into numeric scores for anxiety level and related metrics.

Server estimates physiological emotion indicators using a separate model. Server passes time-aligned time-series physiological information (for example, heart rate, skin conductance, temperature) through a model such as a temporal convolutional network or recurrent network that outputs continuous stress and arousal values. This model may be trained with labels reflecting stress levels collected under controlled conditions.

Server optionally uses a behavior model that analyzes user behavior history stored in a database (for example, path changes, repeated commands, abrupt stops) to infer confusion or “lostness.” This model may be an autoregressive model or a recurrent neural network processing sequences of behavior events.

Server then constructs an emotional state vector. Server concatenates or fuses outputs from the acoustic emotion model, physiological model, and behavior model. Server may use a small feedforward neural network to map these combined features into a vector with explicit dimensions, such as anxiety level, stress level, confusion level, and relaxation level. Server saves this vector along with a timestamp and session identifier.

Server generates an emotion tag by applying a decision rule to the emotional state vector. Server compares each dimension to a threshold or uses a rule-based mapping. For example, server may set a “high-anxiety state” tag if anxiety or stress exceeds a threshold while relaxation remains below a threshold, and a “relaxed state” tag if anxiety, stress, and confusion are low while relaxation is high. Using explicit numeric thresholds and rule-based mapping yields reproducible, well-defined categorization and reduces ambiguity in downstream processing.

### 5. Context Determination and Prompt Sentence Construction

Server determines environment context information. Server uses environment recognition result data and, optionally, geospatial information to derive a context label. Server can classify the current scene as an intersection vicinity when traffic lights and crosswalk markings are present and the map database indicates a road intersection; as a staircase vicinity when steps or stairways are detected; as a commercial area when multiple signs and facility labels indicate shops or restaurants; and as a quiet area when map data indicates a park or residential zone and the number of moving objects is low.

Server combines context label and emotional state to guide dynamic adaptation. Server uses a mapping that relates specific combinations of emotional state and context to guiding policies. For example, if context is intersection vicinity and emotion tag is high-anxiety state, policy is safety-first with minimal information. If context is commercial area and emotion tag is relaxed state, policy is rich descriptive information with optional recommendations.

Server constructs a prompt sentence for a generative AI model. Server implements a prompt generation unit as a program module in the backend framework. Server takes as input:
Environment recognition result data (structured objects describing detected entities and states).
Emotional state vector and emotion tag.
Environment context information.
Parsed user voice command text (if available from an automatic speech recognition module).
User profile information, such as preferred formality level, typical information density, and language and locale.

Server translates these inputs into a natural-language prompt sentence. Server may use templated segments and rule-based assembly logic: server inserts a role instruction (for example, “You are a voice guidance system for a visually impaired user.”), describes the emotional state (“The user is currently very anxious (EMO_STATE=HIGH_ANXIETY).”), summarizes key environment facts (“There is a 15 cm high step 3 meters ahead. A car is approaching from the right. The traffic light is red.”), and adds explicit output conditions controlling length, style, and information priority.

For example, server may construct the following prompt sentence when user is anxious at an intersection:

“You are a voice guidance system for a visually impaired user.

The user is currently very anxious and stressed (EMO_STATE=HIGH_ANXIETY).

Follow these conditions and generate the guide in Japanese as short, clear imperative sentences:
Include only one instruction per sentence.
Prioritize safety information. Do not include unnecessary information.

The current environment recognition results are:
There is a step 3 meters ahead with a height of 15 centimeters.
A car is approaching on the right at a distance of 2 meters.
The traffic light is red.

In this situation, generate 1-3 sentences that allow the user to act safely.”

When user is relaxed in a café area, server may construct:

“You are a sightseeing guide system for a visually impaired user.

The user is currently relaxed and not anxious (EMO_STATE=RELAXED).

Follow these conditions and generate the guide in Japanese with a polite, explanatory tone:
Explain nearby shops and facilities so that the user can enjoy the surroundings.
If there is any safety-related information, briefly mention it first, then add the sightseeing information.

The current environment recognition results are:
There is a café in front named ‘Sunrise Coffee’.
The café menu says: ‘Today's special: coffee and sandwich’.
No particular danger has been detected in the surroundings.

Generate 2-4 sentences of an audio guide that will help the user enjoy walking in this area.”

Server thus encodes multimodal state and policy selection into a single generation prompt sentence. This design is not a simple replacement of human rule-writing; instead, it introduces a formal, machine-generated intermediate representation that can be programmatically controlled and systematically varied. This intermediate representation improves utilization of the generative AI model by providing it with structured context and explicit constraints, which results in more predictable and controllable outputs.

### 6. Generative AI Model Configuration and Training

Server executes a generative AI model configured as a transformer-type language model. The model may consist of multiple layers of self-attention and feed-forward networks, with positional encodings and layer normalization, trained on a large corpus of text data. Server may fine-tune this model on domain-specific data including guidance conversations for visually impaired users.

Server configures hyperparameters such as number of layers, hidden dimension size, number of attention heads, and vocabulary size. Server uses a tokenizer (for example, a subword tokenizer) to map text into token IDs. During training, server minimizes a loss function such as cross-entropy between predicted token distributions and ground-truth tokens, using gradient-based optimization (for example, stochastic gradient descent with momentum or adaptive methods). Server performs backpropagation to update model weights, possibly using learning-rate schedules and regularization (for example, dropout, weight decay).

Server may augment training data by varying formulations of prompts and target responses, adjusting levels of detail, and including examples of safety-critical and descriptive guidance. Data augmentation helps the model generalize to a range of prompt sentence patterns produced by the prompt generation unit.

This explicit training description clarifies that the generative AI model is not an opaque “black box” performing arbitrary inference, but a specific architectural configuration with known learning methods and loss functions, enhancing reproducibility and technical clarity.

### 7. Text Generation and Post-Processing

Server receives the generation prompt sentence from the prompt generation unit and passes it through the tokenizer to obtain input tokens. Server feeds these tokens into the transformer-type language model and runs inference on the GPU. Server uses a decoding strategy such as greedy search, top-k sampling, or beam search to generate output tokens. Server may constrain decoding using maximum length, penalty for repetition, or constraints for sentence boundaries.

Server converts output tokens to text using the tokenizer's reverse mapping. Server then applies post-processing modules. Server checks generated text against a list of prohibited words or patterns and removes or replaces such elements. Server adjusts sentence length by truncating or segmenting text if it exceeds configured limits. Server may modify text style (for example, converting between polite and neutral forms in the target language) by applying rules or additional language-specific transformation models.

Server thereby outputs guide text or response text that both complies with safety and quality requirements and respects user preferences. Server transmits the post-processed text along with the emotion tag and optional context information to terminal. In some embodiments, server also uses a server-side text-to-speech engine to generate audio data and transmits this audio to terminal, reducing processing load on terminal.

### 8. Technical Effects and Improvement of Computer Technology

The described architecture yields multiple technical improvements beyond mere automation of human guidance tasks.

Server uses an integrated sensor data packet to aggregate image, acoustic, and physiological data along with metadata. This unified data structure reduces protocol overhead and simplifies indexing and retrieval, allowing server to process aligned multimodal information more efficiently than if each stream were handled separately. The time alignment improves accuracy of both emotion estimation and environment recognition, since models can rely on consistent temporal relationships.

Server computes an explicit emotional state vector and emotion tag, which are internal machine-readable representations. These representations allow downstream modules to adjust generation behavior with low computational overhead, avoiding frequent re-evaluation of heavy models for each response. This layered design improves computational efficiency and scalability when many users are connected.

Server generates a generation prompt sentence in a systematic, rule-driven manner from structured environment and emotion data. This is a non-conventional use of prompt engineering; server treats the prompt not as an arbitrary human-written string but as a formally generated, parameterized intermediate representation. This yields a technical effect of reducing variability, improving safety control, and enabling dynamic adaptation of style and information density through explicit parameters embedded in the prompt. As a result, the generative AI model behaves more predictably and is easier to validate and monitor. Terminal offloads part of the signal processing (compression, feature extraction, smoothing) to the edge device, reducing server workload and network load while preserving temporal alignment and necessary information content. This distributed processing architecture improves overall system performance and scalability, which is a technical improvement in communication and computation resource management.

Furthermore, by using deep-learning-based environment recognition and emotion estimation models, the system captures patterns and dependencies (for example, joint patterns between physiological and acoustic features) that human operators or simple rules cannot reliably handle in real time. The models apply learned weight matrices and non-linear transformations to high-dimensional data, implementing a processing scheme that goes beyond ordinary manual decision-making processes.

### 9. Alternative Embodiments and Variations

Server may implement alternative neural architectures for environment recognition and emotion estimation. For example, server may replace a recurrent acoustic emotion model with a transformer encoder model, or a convolutional detector with a detection transformer architecture. The core functionality of generating environment recognition result data and emotional state vectors remains unchanged.

Terminal may be implemented as smart glasses, an ear-worn device, or another form factor, provided that it includes an image acquisition unit, audio input/output unit, physiological information acquisition interface, processing unit, and communication interface. Terminal may use different codecs or compression schemes (for example, a different video or audio codec) as long as server can decode them.

Server may integrate additional inputs, such as environmental noise level or external event feeds, into context determination and prompt generation. Server may also implement different threshold values or more complex rules for deriving emotion tags from emotional state vectors.

In some embodiments, terminal may perform part of the environment recognition locally (for example, running a lightweight object detector on the terminal's processing unit) and send partial recognition results to server, which then refines or combines them with server-side models. This variation may reduce latency in time-critical scenarios by enabling faster local feedback.

In all embodiments, terminal and server cooperate so that the generative AI model produces guidance texts that adapt to user's emotional state and environmental context, and so that the internal data structures (integrated sensor data packet, emotional state vector, emotion tag, generation prompt sentence) and computational processes improve the technical functioning of the system as a whole, rather than merely replicating human guidance behavior.

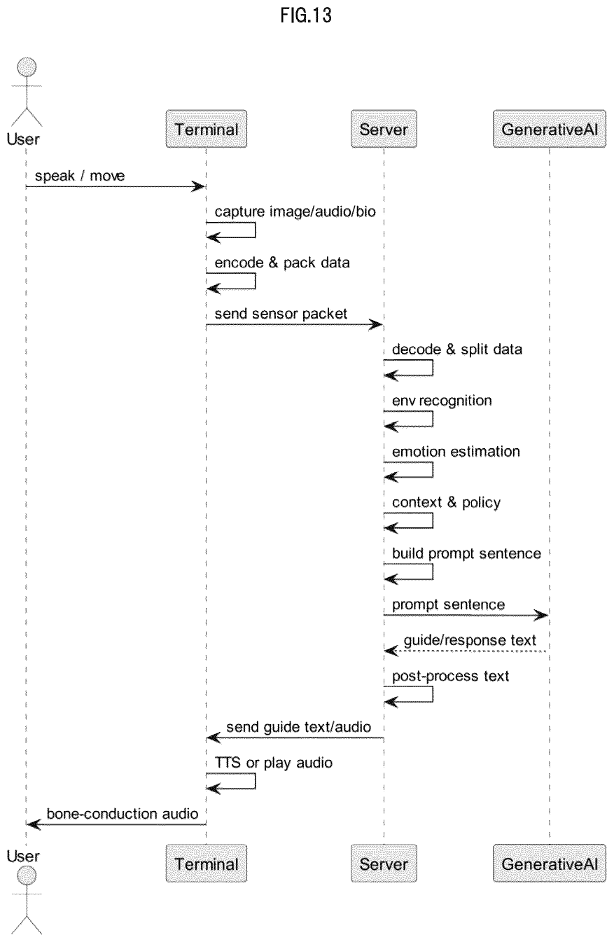

The following describes the processing flow using FIG. 13.

### Step 1:

Terminal acquires and timestamps image data.

Terminal uses the camera control API of the wearable operating system to drive the image acquisition unit and requests continuous capture at a preset frame rate and resolution. As input, terminal receives raw pixel frames from the image sensor. Terminal reads the current time from an internal clock and position information from a location service, and terminal combines each raw frame with its timestamp and position to produce structured image records as output. Terminal thus performs data formatting and metadata attachment on the raw image data.

### Step 2:

Terminal compresses image records into a video bitstream.

Terminal takes the structured image records as input and passes the raw pixel arrays to a multimedia encoder library. Terminal configures codec parameters such as bit rate, frame interval, and compression profile, and terminal performs transform, quantization, and entropy coding operations to convert the sequence of frames into a compressed video bitstream. As output, terminal generates encoded video chunks with references to associated timestamps and positions, thereby reducing data size while preserving temporal and spatial metadata.

### Step 3:

Terminal detects speech segments and computes acoustic features.

Terminal uses the audio input unit to capture a continuous stream of PCM audio samples as input. Terminal divides the stream into short overlapping windows and applies a voice activity detection algorithm that computes, for each window, metrics such as energy and spectral characteristics, and classifies the window as speech or non-speech. Terminal groups consecutive speech windows into utterance segments and records start and end times. For each utterance segment, terminal applies a feature-extraction library that performs Fourier transforms and filterbank integrations to compute MFCCs, energy, and pitch values. As output, terminal generates acoustic feature sequences associated with utterance interval information.

### Step 4:

Terminal acquires and smooths physiological signals.

Terminal receives, as input, raw physiological samples such as heart rate, skin conductance, and skin temperature from built-in biosensors or from an external wearable device via a short-range wireless communication mechanism. Terminal timestamps each incoming sample using the internal clock. Terminal then applies digital filtering operations, such as moving-average or low-pass filtering, to each time series to reduce noise and transient spikes. As output, terminal produces smoothed time-series physiological information aligned in time with the audio and image data.

### Step 5:

Terminal constructs an integrated sensor data packet.

Terminal takes encoded video chunks, acoustic feature sequences, smoothed physiological time series, and identification metadata (user ID, device ID, session ID) as input. Terminal maps these elements into a predefined message structure, assigning fields for each modality and metadata. Terminal invokes a serializer library that converts the structured message into a compact binary or textual representation by performing field encoding and length delimiting. As output, terminal generates an integrated sensor data packet ready for network transmission.

### Step 6:

Terminal transmits the integrated sensor data packet to server.

Terminal uses an HTTPS client library to create a secure HTTP request, taking the integrated sensor data packet as input. Terminal sets request headers, including content type and authentication tokens, and writes the serialized packet into the request body. Terminal invokes the operating system's networking stack to perform TCP/IP transmission to a designated server endpoint. As output, terminal generates a network message on the communication channel and receives, in response, an acknowledgment or later a guidance response from server.

### Step 7:

Server receives and deserializes the integrated sensor data packet.

Server accepts an HTTPS request from terminal via a REST endpoint, receiving the serialized packet as input. Server passes the raw request body to a deserializer library, which parses field tags, lengths, and values to reconstruct the original structured objects for video chunks, acoustic feature data, physiological data, and metadata. Server allocates memory for these objects and associates them with the user and session identified in the metadata. As output, server produces in-memory representations of multimodal data streams.

### Step 8:

Server decodes image data into timestamped frames.

Server takes encoded video chunks from the structured objects as input and passes them to a multimedia decoding library. Server performs inverse entropy decoding, dequantization, and inverse transform operations to reconstruct pixel arrays for each frame. Server restores the mapping between frames and their timestamps and position information using the metadata that accompanied the chunks. As output, server generates a time-ordered list of timestamped frames with associated location data.

### Step 9:

Server performs environment recognition using vision models and OCR.

Server uses the timestamped frames as input to a set of trained neural-network models and an OCR engine. For each frame, server resizes and normalizes pixels and feeds the preprocessed frame into an object detection model, which performs convolution, non-linear activation, and bounding-box regression to compute object class probabilities and box coordinates. Server filters detections and labels objects such as pedestrians, vehicles, traffic lights, steps, doors, and obstacles. Server applies a face detection and embedding model to face regions and compares embeddings against stored references using similarity computations. Server uses a text detection model to locate text regions and passes cropped regions to an OCR engine, which segments characters and maps pixel patterns to character codes. As output, server assembles environment recognition result data that lists detected objects, positions, distances, identified persons, and recognized text strings.

### Step 10:

Server refines environment recognition with traffic, step, and distance analysis.

Server takes environment recognition detections and raw frame data as input. For regions labeled as traffic lights, server crops the image and applies either a color analysis algorithm that computes color histograms or a small classifier network to determine the indication state (for example, red, yellow, green). For regions labeled as steps or stairs, server applies a depth or disparity estimation algorithm that processes either stereo pairs or sequential frames to calculate depth maps, and from these depth maps server computes distances and heights. Server attaches these refined attributes to the corresponding entries in the environment recognition result data. As output, server produces an enhanced environment representation that includes detailed geometric and state information.

### Step 11:

Server estimates emotional state from acoustic and physiological features.

Server uses acoustic feature sequences and smoothed physiological time series as input. Server passes acoustic sequences to an acoustic emotion model, which may apply recurrent or transformer layers to process temporal correlations and outputs probabilities over emotion categories. Server passes physiological sequences to a physiological model that uses temporal convolutions or recurrent layers to produce continuous stress and arousal indices. Server optionally uses a behavior model that takes user behavior history as input and outputs confusion scores. Server concatenates these outputs and feeds them into a fusion network that performs weighted summation and non-linear activation to produce an emotional state vector. Server then applies threshold-based rules to this vector to derive an emotion tag. As output, server obtains both the emotional state vector and the emotion tag for the current time window.

### Step 12:

Server determines environment context information.

Server takes environment recognition result data and geographical information as input.

Server queries a map or geographic information service with the current position and analyzes the types and density of recognized entities. Server applies rule sets that, for example, classify a scene as an intersection vicinity when crosswalks and traffic signals are present, or as a commercial area when multiple shop signs and facility labels are detected. As output, server assigns an environment context label indicating at least one of intersection vicinity, staircase vicinity, commercial area, or quiet area.

### Step 13:

Server selects guidance policy parameters based on emotion and context.

Server uses the emotion tag and environment context label as input. Server consults a policy table or rule base that maps combinations of emotion and context to guidance parameters, such as desired output style, maximum number of sentences, and priority of safety versus descriptive content. For example, server selects a concise, imperative style with strict focus on safety when the emotion tag indicates high anxiety in an intersection context. As output, server produces a set of policy parameters that will guide the construction of the prompt sentence.

### Step 14:

Server constructs a generation prompt sentence for the generative AI model.

Server takes environment recognition result data, emotional state vector, emotion tag, environment context label, policy parameters, user profile information, and parsed user command text as input. Server generates text fragments: a role instruction, an emotional state description, an environment summary, and output condition instructions. Server then assembles these fragments in a predetermined order, inserting content such as distances, object names, and safety warnings derived from the environment recognition result data, and style and length constraints derived from the policy parameters and user profile. Server performs string concatenation and formatting operations to produce a coherent generation prompt sentence in a target language. As output, server provides this prompt sentence as the input specification for the generative AI model.

### Step 15:

Server generates guide text or response text using the generative AI model.

Server takes the generation prompt sentence as input and passes it to a tokenizer that maps characters or subwords to token IDs. Server feeds the resulting token sequence into a transformer-type language model, which processes the sequence through multiple attention and feed-forward layers, computing contextual embeddings and predicting distributions over next tokens. Server applies a decoding algorithm, such as greedy decoding or top-k sampling, repeatedly sampling or selecting tokens based on the predicted distributions until an end condition is met. Server converts the output token sequence back to text. As output, server obtains raw guide text or response text generated in accordance with the constraints encoded in the prompt sentence.

### Step 16:

Server post-processes generated text and prepares a response message.

Server takes the raw guide text or response text and the emotion tag as input. Server applies post-processing: it scans for prohibited words by comparing tokens to a banned list and replaces or removes them; it enforces sentence length bounds by truncating or splitting overly long sentences; and it adjusts style if necessary by applying language-specific transformation rules. Server then constructs a response object that includes the post-processed text, the emotion tag, and optional context metadata. Server serializes this object, for example as a structured message, and sends it back to terminal via the HTTPS response. As output, server delivers a guidance payload tailored to the user's current state and environment.

### Step 17:

Terminal generates or plays back audio guidance.

Terminal receives the response object from server as input and parses it to extract guide text, response text, and metadata. If only text is present, terminal passes this text to a local text-to-speech engine, which converts it into PCM audio samples by applying linguistic analysis, acoustic model inference, and waveform synthesis. If pre-synthesized audio data is present, terminal decodes the compressed audio stream into PCM samples. Terminal then retrieves user preferences and estimates ambient noise level by sampling microphone input. Terminal computes an appropriate playback gain and any equalization or noise suppression parameters and configures the audio driver accordingly. As output, terminal sends the processed PCM audio to the bone-conduction output mechanism, causing the user to perceive guidance audio while still hearing environmental sounds.

### Step 18:

User listens to guidance and provides behavioral and voice feedback.

User receives, as input, the guidance audio via the bone-conduction output mechanism and ambient environmental sound through normal hearing. User interprets the instructions, such as “Stop,” “Wait for the green light,” or “There is a café on your right,” and performs physical actions such as stopping, turning, or walking toward a facility. User also issues new voice commands in response to the situation, for example asking for location or requesting recommendations. As output, user produces new speech signals that terminal captures and processes, feeding back into the earlier steps so that server can update environment recognition, emotion estimation, prompt sentence generation, and generative AI-based guidance.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional assistive systems for users with visual impairments typically capture environmental information using image sensors, perform recognition processing using machine learning, and provide guidance via audio output. However, such systems generally treat recognition and guidance as a one-way pipeline that produces fixed, template-based messages from objective scene descriptions. As a result, they are unable to adapt the guidance content, tone, and information density to the user's current emotional state, and they cannot fully utilize modern generative AI models in a structured and controllable manner.

From a computing technology standpoint, existing architectures present several technical deficiencies. First, image recognition, emotion estimation, and natural language generation are often implemented as independent modules that exchange loosely structured data, leading to inefficient data flows, redundant preprocessing, and difficulty in synchronizing multimodal information (image frames, speech transcripts, and prosodic or facial features). Second, when generative AI models such as large-scale neural network language models are used, they are typically driven by ad hoc, unstructured text prompts that are manually crafted or statically defined. This causes non-deterministic behavior, makes it difficult to constrain the model's output format and tone, and prevents systematic control of the generated text in accordance with real-time sensor data and user state.

Third, conventional systems do not treat the construction of the prompt sentence itself as a first-class computational operation that integrates environment recognition results, time-series emotion estimation results, and user queries. Hence, they cannot dynamically adjust instructions to the generative AI model based on long-term emotional trends, multi-object spatial layouts, and recognized text in the environment. This leads to technical problems such as unnecessary network traffic due to repeated or overly verbose responses, increased computational load caused by repeated generation attempts to correct unsatisfactory outputs, and latency in real-time guidance because the system cannot predictably shape the generative model's behavior.

Furthermore, while multimodal emotion estimation techniques are known, they are rarely bound in a unified processing flow that: (i) computes emotion categories from time-series feature vectors, (ii) stores and analyzes an emotional history, and (iii) feeds derived, machine-interpretable emotional state parameters directly into the prompt construction logic. As a result, computing resources in the server and terminal are not optimally used, and the quality and consistency of generated guidance cannot be guaranteed under varying communication conditions and environmental contexts.

Accordingly, there is a need for an improved computer-implemented system and processing architecture in which a processor efficiently acquires and synchronizes multimodal data from a terminal, performs environment recognition and emotion estimation in an integrated manner, constructs a structured and parameterized prompt sentence according to predefined templates or rules, and drives a generative AI model so that its output is constrained and adapted to the user's environment and emotional state. Such a system should improve the technical behavior of the computing stack itself by reducing processing redundancy, stabilizing the quality of generative outputs, and enabling real-time, emotionally adaptive guidance with predictable latency and resource usage.

The specific processing by the specific processing unit 290 of the data processing device 12 in Application Example 2 is realized by the following means.

The present invention provides a server comprising a processor configured to receive, via a communication interface, image data, a speech recognition result, and emotion estimation feature values from a terminal device, execute, by an environment recognition unit, at least one of object recognition, person recognition, and character recognition on the image data to generate an environment recognition result as structured data, estimate, by an emotion estimation unit, an emotional state of a user by inputting time-series data of the emotion estimation feature values and, when available, facial expression feature values extracted from the image data into a machine learning model to calculate scores corresponding to a plurality of emotion categories, generate, by a prompt generation unit, a structured prompt sentence to be input to a generative AI model implemented by a large-scale neural network for generative processing, the structured prompt sentence including a description part that explains at least a current situation and a psychological state of the user based on the environment recognition result and the estimated emotional state, and an instruction part that specifies at least one of an output format, a language, a number of sentences, a tone, and content constraints for text to be generated by the generative AI model, generate, by a text generation unit, guidance text or dialogue response text by inputting the structured prompt sentence into the generative AI model, generate, by a speech synthesis unit, audio data based on at least one of the guidance text and the dialogue response text, and transmit, by an audio data transmission unit, the audio data to the terminal device via the communication interface. This enables the computing system to integrate multimodal recognition and time-series emotion estimation into a controlled prompt-driven generative pipeline, thereby improving technical performance by stabilizing the behavior of the generative AI model, reducing redundant processing and network traffic, and providing low-latency, emotionally adaptive voice guidance tailored to the user's real-time environment and emotional state.

The term “imaging unit” refers to a hardware and software combination configured to optically capture an environment around a user and to output the captured information as digital image data, including at least one image sensor, optics, and control software executed by a processor.

The term “audio acquisition unit” refers to a hardware and software combination configured to receive uttered voice of a user as an acoustic signal and to output the uttered voice as a digital audio signal, including at least one microphone, an analog-to-digital converter, and control software executed by a processor.

The term “audio analysis unit” refers to a functional module implemented by software executed by a processor and optionally dedicated hardware, the module being configured to analyze a digital audio signal to extract a speech recognition result representing textual content of a user's utterance and emotion estimation feature values representing numerical parameters used for estimating an emotional state of the user.

The term “emotion estimation feature values” refers to numerical data derived from at least one of an audio signal and an image signal, including parameters such as volume, fundamental frequency, speaking rate, silence duration, and facial expression indicators, which are used as input values for estimating an emotional state of a user.

The term “transmission unit” refers to a hardware and software combination configured to send data from a terminal device to a server via a communication path, the combination including at least one communication interface, a network protocol stack, and control software executed by a processor.

The term “server” refers to an information processing apparatus, which may be implemented as one or more physical or virtual machines, including at least one processor, a memory, a communication interface, and software modules configured to execute environment recognition, emotion estimation, prompt generation, text generation, and speech synthesis.

The term “environment recognition unit” refers to a functional module implemented by software executed by a processor and optionally dedicated hardware, the module being configured to execute at least one of object recognition, person recognition, and character recognition on image data to generate an environment recognition result as structured data describing an environment around a user.

The term “object recognition” refers to processing in which image data are analyzed by a machine learning algorithm or another pattern recognition algorithm to detect and classify physical objects, and to determine at least a type and a position of each detected object.

The term “person recognition” refers to processing in which image data are analyzed to detect a region corresponding to a person or a face and to identify or verify the person by comparing extracted features with reference data stored in a database.

The term “character recognition” refers to processing in which image data are analyzed to detect regions containing characters or symbols and to convert the characters or symbols into machine-readable text data.

The term “environment recognition result” refers to structured data generated by the environment recognition unit, the data including at least one of an object type, an object position, a person identification result, and a character recognition result that collectively describe an environment around a user.

The term “emotion estimation unit” refers to a functional module implemented by software executed by a processor and optionally dedicated hardware, the module being configured to input emotion estimation feature values and, when available, facial expression feature values into a machine learning model to calculate scores for a plurality of emotion categories and to estimate an emotional state of a user based on the scores.

The term “facial expression feature values” refers to numerical data representing at least one aspect of a facial expression of a user, the numerical data being extracted from image data and used as input values for estimating an emotional state of the user.

The term “emotional state” refers to information representing a psychological condition of a user, expressed as at least one of a discrete category, such as anxiety, joy, calmness, anger, or sadness, and a numerical score associated with such a category.

The term “prompt generation unit” refers to a functional module implemented by software executed by a processor, the module being configured to generate a prompt sentence to be input to a generative AI model, the prompt sentence being constructed as structured text based on at least an environment recognition result, an emotional state, and a speech recognition result.

The term “prompt sentence” refers to text data serving as an input query to a generative AI model, the text data including at least a description part that describes a situation and a psychological state of a user and an instruction part that specifies constraints and requirements for text to be generated by the generative AI model.

The term “generative AI model” refers to a generative model implemented by a large-scale neural network, trained using machine learning to generate text or other data in response to an input, and including at least a language model configured to output text based on a prompt sentence.

The term “large-scale neural network for generative processing” refers to a neural network having a plurality of layers and a large number of parameters, trained on extensive training data to perform generative tasks such as natural language generation when provided with input data including a prompt sentence.

The term “text generation unit” refers to a functional module implemented by software executed by a processor, the module being configured to input a prompt sentence into a generative AI model and to obtain, as an output from the generative AI model, guidance text or dialogue response text.

The term “guidance text” refers to text data generated for the purpose of providing procedural or situational guidance to a user, including instructions related to movement, safety, or interaction with an environment.

The term “dialogue response text” refers to text data generated in response to a question or command from a user, the text data being suitable for use in conversational interaction with the user.

The term “speech synthesis unit” refers to a functional module implemented by software executed by a processor and optionally dedicated hardware, the module being configured to convert text data, including at least one of guidance text and dialogue response text, into audio data representing synthesized speech.

The term “audio data transmission unit” refers to a hardware and software combination configured to transmit audio data from a server to a terminal device via a communication path, including at least one communication interface, a network protocol stack, and control software executed by a processor.

The term “terminal” refers to a user-side information processing apparatus, including at least one processor, a memory, an imaging unit, an audio acquisition unit, a communication interface, and an audio output unit, which is configured to communicate with a server and to present information to a user.

The term “audio output unit” refers to a hardware and software combination configured to decode audio data received from a server and to output the decoded audio data as sound to a user, including at least one digital-to-analog converter, an amplifier, and an output transducer.

The term “bone conduction output device” refers to a transducer configured to convert electrical audio signals into mechanical vibrations transmitted through bones of a user's head, thereby enabling the user to perceive sound without relying primarily on air conduction through the ear canal.

The term “communication path” refers to a logical and physical pathway used for data transmission between a terminal device and a server, including at least one wired or wireless communication network and associated protocols.

In one embodiment, a system includes a terminal worn by a user with a visual impairment and a server connected to the terminal via a communication network. The terminal and the server cooperate to capture multimodal information from the real world, to perform recognition and emotion estimation using specific machine learning algorithms, to generate a structured prompt sentence for a generative AI model, and to synthesize and output emotionally adaptive guidance audio through bone conduction. The following describes exemplary hardware, software, data structures, and processing methods for implementing the invention.

### A. OVERALL SYSTEM CONFIGURATION

The terminal includes at least one processor, a memory, an imaging unit, an audio acquisition unit, a communication interface, and an audio output unit. The terminal is, for example, implemented as a glasses-type device or as a mobile device carried by the user.

The server includes at least one processor, a memory, a communication interface, storage, and software modules implementing an environment recognition unit, an emotion estimation unit, a prompt generation unit, a text generation unit, and a speech synthesis unit. The server may use general-purpose processors and one or more graphics processing units (GPUs).

The terminal and the server communicate via a wired or wireless communication path, such as a cellular network or a wireless local area network, using a transport protocol and an application-level protocol such as a secure HTTP-based protocol or a remote procedure call protocol.

### B. TERMINAL-SIDE CONFIGURATION

### 1. Imaging Unit

The terminal uses an imaging unit to acquire images of the environment around the user. The imaging unit includes a wide-angle solid-state image sensor, lenses, an analog front-end, and a driver. The terminal executes a camera control program on a mobile operating system to configure exposure time, gain, frame rate, and resolution.

The terminal uses an image processing library, for example, an open-source image processing library, to perform preprocessing. The terminal converts raw sensor values into RGB images, corrects lens distortion, performs image stabilization by computing frame-to-frame motion vectors and applying affine transformations, and performs brightness and contrast adjustments by computing luminance histograms and applying nonlinear mapping functions. In low-light conditions, the terminal reads signals from an infrared sensor, converts them into grayscale matrices, and merges them with visible-light images using weighted pixelwise addition to improve visibility.

By performing these preprocessing operations at the terminal, the system reduces noise and dynamic artifacts in the frames before they are transmitted. This reduces the amount of information the server must compensate for, improves recognition accuracy, and reduces redundant recomputation at the server. In particular, stabilized and brightness-normalized images improve convergence of convolutional neural network inference at the server.

### 2. Audio Acquisition Unit and Audio Analysis Unit

The terminal uses an audio acquisition unit that includes at least one bone-conduction microphone and at least one air-conduction microphone. The terminal samples analog signals from the microphones with an analog-to-digital converter at a predetermined sampling rate (for example, 16 kHz, 16-bit) and uses the operating system's audio input interface to buffer frames of the digitized audio.

The terminal executes a speech recognition client program. The terminal can use an on-device speech recognition engine, such as a model implemented by a general-purpose machine learning library, or can call an external speech recognition service via an API. The terminal segments the audio signal into overlapping frames, computes spectral features such as Mel-frequency cepstral coefficients (MFCCs), and inputs these features into an acoustic model. The acoustic model may be implemented as a deep neural network, such as a time-delay neural network or a recurrent neural network, trained to output phonetic or subword units. A decoding module uses a language model and a search algorithm to produce a speech recognition result as a text string.

The terminal also executes an audio analysis module to compute emotion estimation feature values. The terminal uses a signal processing library, for example, a speech analysis library, to calculate, for each frame or group of frames, at least the following:
short-term energy and root-mean-square amplitude as volume features,
fundamental frequency using an autocorrelation-based or cepstral-based pitch detection algorithm,
speaking rate by counting voiced segments and syllable-like events per unit time,
silence durations by detecting segments below an energy threshold and measuring their lengths.

The terminal aggregates these values into structured feature vectors, each vector corresponding to a time interval and containing numerical fields such as average energy, average fundamental frequency, variation of fundamental frequency, speech duty ratio, and silence segment statistics. The terminal associates a time stamp or a frame index with each feature vector.

By extracting and structuring emotion estimation feature values at the terminal, the system reduces the volume of raw audio transmitted to the server and provides a compact, machine-interpretable representation optimized for emotion estimation. This improves communication efficiency and reduces server-side preprocessing load.

### 3. Communication Interface

The terminal uses a communication interface including a wireless modem, an antenna, and a protocol stack to connect to the server. The terminal uses an encryption library to establish a secure communication channel and uses a serialization format, such as a binary structured data format, to encode image data, speech recognition results, and emotion estimation feature values. The terminal assigns a session identifier to each set of data captured during a time window and transmits the data to the server.

### C. SERVER-SIDE CONFIGURATION

### 1. Environment Recognition Unit

The server uses an environment recognition unit to analyze the image data received from the terminal. The server loads an object detection model implemented by a deep learning framework, such as a convolutional neural network configured for object detection.

In one embodiment, the server uses a convolutional backbone network with multiple convolution and pooling layers to extract feature maps from each input image. The server then applies detection heads to these feature maps to predict bounding boxes and class probabilities for objects. The server classifies objects into categories such as furniture, domestic appliances, doors, stairs, and obstacles.

The server also performs person recognition. The server uses a face detection algorithm, such as a multi-stage convolutional detector, to identify candidate facial regions. The server uses a face embedding model, which is a deep neural network trained with a metric learning loss function, such as a triplet loss or a contrastive loss, to map each detected face region into an embedding space. The server compares each embedding with reference embeddings stored in a database by computing a similarity measure such as cosine similarity, and identifies persons such as family members or caregivers if the similarity exceeds a threshold.

The server further performs character recognition. The server detects regions that may contain text by analyzing image gradients and using region proposal algorithms. The server normalizes these regions, for example by resizing and binarization, and applies an optical character recognition engine to convert image patches into character sequences. The server may use a recurrent neural network-based recognizer or a transformer-based recognizer.

The server integrates the results into an environment recognition result, which is a structured data object, for example, containing fields for object type, object position coordinates, person identifier, and recognized text. By structuring the data, the server can access and manipulate environmental information in a deterministic way, which enables the subsequent prompt generation logic to be rule-based rather than heuristic.

The use of a dedicated environment recognition unit, with explicit data structures and recognition pipelines, improves technical performance by reducing ambiguity in the representation of the environment and by enabling the server to reuse intermediate features across tasks, such as using the same backbone features for both object detection and person recognition.

### 2. Emotion Estimation Unit

The server uses an emotion estimation unit to estimate the emotional state of the user. The server receives the time-series emotion estimation feature values from the terminal and, in some embodiments, also extracts facial expression feature values by applying a facial expression analysis model to images that include the user's face.

The server implements an emotion classification model using a machine learning library. In one embodiment, the server uses a recurrent neural network, such as a long short-term memory (LSTM) network, which inputs sequences of feature vectors. Each feature vector contains audio-based features, such as normalized volume, normalized fundamental frequency, temporal variation of fundamental frequency, speaking rate, and silence ratio, and may include facial expression-based features, such as action unit intensities or probabilities of basic facial expressions.

The server normalizes each dimension of the feature vectors by subtracting a mean and dividing by a standard deviation estimated from training data. The server inputs the normalized sequences into the LSTM network. The LSTM network consists of multiple layers of recurrent units, each with input, output, and forget gates, and hidden states. The network outputs, at the final time step or at multiple time steps, a vector of scores, each score corresponding to one of several emotion categories, such as anxiety, joy, calmness, anger, and sadness.

The server applies a softmax function to the score vector to obtain probabilities for each category and selects the category with the highest probability as the current emotional state. The server also retains the full probability distribution as confidence values and stores the emotional state in association with a time stamp in a database.

The server analyzes the stored history to derive long-term trends. For example, the server may maintain a sliding window over the last several days, count occurrences of each emotion category, and compute a trend indicator that describes whether anxiety has been persistent. This trend indicator is used as an additional parameter in prompt generation.

This configuration improves technical performance in several ways. By using a dedicated time-series model for emotion classification, the server can capture temporal patterns that are difficult for a human observer to track, such as subtle fluctuations in prosody or micro-expressions. By normalizing feature vectors and using an LSTM architecture, the server reduces sensitivity to noise and missing data, leading to a more stable emotional state estimate. This, in turn, stabilizes the behavior of the downstream generative AI model, because the model receives consistent and reliable emotional context.

### 3. Prompt Generation Unit

The server uses a prompt generation unit to construct a prompt sentence for a generative AI model. The prompt generation unit is implemented as a software module that operates on structured data rather than unstructured text. The prompt generation unit receives at least an environment recognition result, an emotional state, and a speech recognition result.

The server stores a set of templates and rules. Each template defines a structure of a prompt sentence, including a description part and an instruction part. The description part contains placeholders for elements such as environment description, emotional state, user query, and contextual information. The instruction part contains placeholders for instructions to the generative AI model, such as output language, maximum number of sentences, tone, and content restrictions.

The server selects an appropriate template based on conditions. For example, when the environment recognition result includes a nearby obstacle and the user is moving, the server selects a movement guidance template. When the speech recognition result contains a question about a schedule and a recognized calendar entry or database includes relevant schedule information, the server selects a schedule explanation template. When the emotional history indicates sustained anxiety, the server selects a long-term support template.

The server binds values from the environment recognition result and the emotion estimation unit into the placeholders. For example, the server inserts a room name, a distance value, and an object type into the environment description, and inserts the emotion label and trend into the emotional description. The server inserts the user's question as recognized by the speech recognition engine and inserts schedule information retrieved from a data store.

The server then concatenates strings according to the template. An example of a prompt sentence for movement guidance is:

“You are a care support assistant for an elderly user with visual impairment.

The user is currently in an ‘anxious’ state, and it is important to provide reassurance.

Environment information: The user is walking forward in the living room, and there is a sofa 1.5 meters ahead.

Instruction: In Japanese, generate at most two sentences of a gentle voice guidance message that safely guides the user to avoid bumping into the sofa.”

An example of a prompt sentence for schedule explanation is:

“You are a schedule guidance assistant for an elderly user with visual impairment.

The user's current emotional state is ‘anxiety’.

User's question: ‘When is my next visitor coming?’

Database information: ‘The visitor is scheduled to arrive today at 3 PM.’

Instruction: In Japanese, generate one or two sentences that convey this information in a calm tone that helps relieve the user's anxiety.”

An example of a prompt sentence for long-term emotional support is:

“You are a long-term care assistant engaging in ongoing conversations with an elderly user with visual impairment.

The user has been in an anxious state for several days recently.

Instruction: Generate a short message in Japanese that gently suggests, without blaming the user, that they may want to talk to family members or care staff about how they are feeling.” By generating prompt sentences in a structured and rule-based manner, the server ensures that the generative AI model receives consistent instructions. This reduces the variability of outputs, improves adherence to safety constraints, and reduces the need to repeat generation with modified prompts. The use of structured templates, combined with the environment recognition result and emotion state parameters, is not a mere automation of human prompt writing; rather, it creates a new data flow and control mechanism inside the computing system that improves predictability and computational efficiency.

### 4. Text Generation Unit and Generative AI Model

The server uses a text generation unit to interface with a generative AI model. In one embodiment, the generative AI model is a large-scale neural network language model implemented as a transformer architecture. The model includes an embedding layer, multiple self-attention layers, feed-forward layers, and a final output layer that produces a probability distribution over vocabulary tokens.

The server tokenizes the prompt sentence into tokens using a tokenizer associated with the model. The server maps each token to an embedding vector, aggregates these vectors into a sequence, and feeds the sequence into the model. The model performs multi-head self-attention, computing attention weights between tokens and updating hidden states through matrix multiplications and nonlinear activation functions. The model then produces logits for the next token, which the server converts to probabilities using a softmax function.

The server uses generation parameters such as maximum length, temperature, and nucleus sampling probability to control the generation process. The server iteratively generates tokens until an end-of-sequence token is reached or a length limit is met, then decodes the tokens into text to obtain guidance text or dialogue response text.

Training of the generative AI model is performed offline using a large corpus of training data.

The server uses a loss function such as cross-entropy loss between predicted token distributions and ground-truth token sequences. The server updates the model parameters using a gradient-based optimization algorithm such as stochastic gradient descent with adaptive learning rate. The server may employ data augmentation methods, such as back-translation or paraphrasing, to increase robustness.

By using the structured prompt sentence with explicit description and instruction parts, the generative AI model operates under constrained conditions. This reduces the risk of generating irrelevant or overly verbose text, which in turn reduces communication bandwidth and processing overhead needed for subsequent steps such as audio synthesis and transmission.

### 5. Speech Synthesis Unit

The server uses a speech synthesis unit to convert text into audio data. The server invokes a text-to-speech engine. The engine includes a linguistic front-end that converts text into phonetic and prosodic features, an acoustic model that predicts acoustic parameters from the linguistic features, and a vocoder that generates a waveform.

The server configures the engine with parameters based on the emotional state. When the user is anxious, the engine sets a slower speaking rate and a softer prosody. When the user is calm, the engine uses a standard speaking rate and neutral prosody.

The server generates digital audio samples, such as 16-bit PCM at 16 kHz or 22.05 kHz, and encodes them into a compressed format if desired, such as an audio codec, to reduce data size.

The server sends the audio data to the terminal through the communication interface.

### D. TECHNICAL EFFECTS AND ADVANTAGES

The system provides several technical improvements over conventional configurations:

The server reduces processing redundancy by splitting preprocessing tasks between the terminal and the server. The terminal performs image stabilization and audio feature extraction, while the server performs high-cost deep learning inference. This division reduces network traffic and server load, allowing the system to support more users concurrently.

The server improves accuracy of guidance by combining object recognition, person recognition, and character recognition into a unified environment recognition result. Because the result is represented as structured data, the prompt generation unit can apply precise rules and conditions, thereby reducing errors in the instructions given to the generative AI model.

The server improves latency and predictability by using a dedicated emotion estimation unit with time-series modeling. The model produces stable emotional state estimates even in noisy environments, which stabilizes the parameters used in prompt generation and reduces fluctuations in guidance tone. As a result, the generative AI model does not need to be repeatedly re-invoked due to unsatisfactory tone or content.

The system improves data management by storing environment recognition results and emotional histories in structured databases. The prompt generation unit can access these histories to adjust instructions based on long-term trends. This is not simply storing logs; it is a controlled feedback mechanism from past emotional patterns into current prompt construction, improving personalization with minimal additional computation.

The system also reduces communication load by transmitting compact feature vectors for emotion estimation rather than raw audio, and by constraining generated text length via explicit parameters in the prompt sentence. The use of templates that specify maximum number of sentences and concise output ensures that network traffic for audio data remains bounded.

### E. ALTERNATIVE EMBODIMENTS AND VARIATIONS

The server may use different neural network architectures for environment recognition, such as transformer-based vision models or hybrid convolution-transformer networks. The server may replace or augment the LSTM network in the emotion estimation unit with a convolutional sequence model or a transformer-based sequence model.

The server may employ different template sets in the prompt generation unit, for example templates for indoor navigation, outdoor navigation, medication reminders, or emergency response. The server may also dynamically select templates based on recognized objects, such as a stove or a wet floor, to provide context-sensitive safety warnings.

The terminal may be implemented as a smartphone paired with a head-mounted camera and bone-conduction earphones. In this case, the imaging unit and audio output unit may be distributed across multiple physical devices, but they still operate as logical components of the terminal.

The system may also adapt to different languages by modifying the instruction part of the prompt sentence to specify the target output language, and by using language-specific text-to-speech engines.

In all these embodiments, the key technical feature is that the server does not merely execute generic data acquisition, analysis, and display operations. Instead, the server constructs a structured prompt sentence based on synchronized multimodal, time-series data and drives a generative AI model under explicit constraints, thereby improving the internal operation of the computing system in terms of accuracy, stability, latency, and resource usage, and providing safe and emotionally adaptive guidance to the user in the real world.

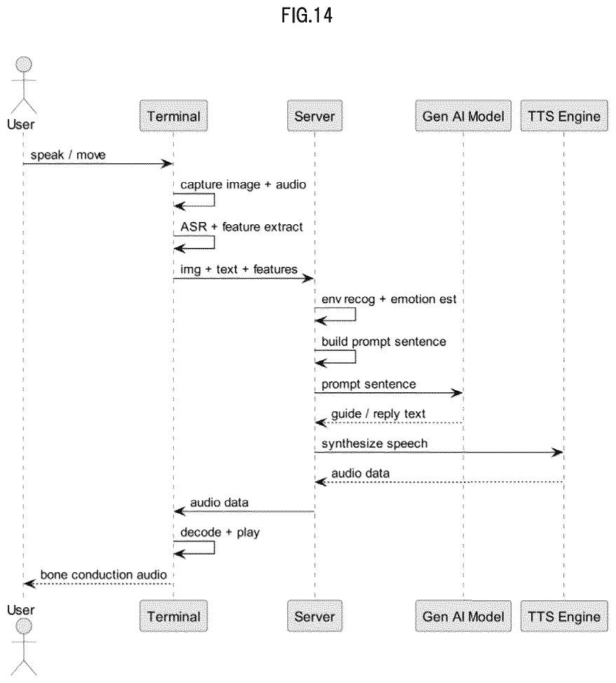

The following describes the processing flow using FIG. 14.

### Step 1:

The user wears the terminal and behaves in daily life.

The user moves, walks, or performs ordinary actions while the terminal is powered on.

The user speaks naturally to the terminal, for example, “What is in front of me?” or “When is my next visitor coming?”.

The input in this step is the user's physical movement in the real environment and the user's raw speech.

The output in this step is the physical situation in front of the user and analog acoustic signals that will be sensed by the terminal's sensors.

### Step 2:

The terminal captures images of the environment.

The terminal uses the imaging unit, including a wide-angle solid-state image sensor and a camera control program on a mobile operating system, to acquire frames at a fixed frame rate (for example, 30 frames per second).

The terminal applies an image processing library to perform lens distortion correction, image stabilization, and brightness/contrast adjustment. In low light, the terminal merges infrared sensor data with visible-light images by pixelwise weighted addition.

The input in this step is analog optical signals and, when available, infrared signals from the surrounding environment.

The terminal converts these analog signals into digital image matrices, applies geometric and photometric transformations to reduce noise and correct motion, and outputs a time-stamped sequence of preprocessed image frames as image data.

### Step 3:

The terminal acquires and analyzes the user's speech.

The terminal uses the audio acquisition unit, including bone-conduction and air-conduction microphones, to capture analog audio waveforms of the user's utterances.

The terminal digitizes the waveforms via an analog-to-digital converter and segments them into short frames (e.g., 20-30 ms).

The terminal sends these frames to a speech recognition engine and to an audio feature extraction module. The speech recognition engine converts spectral features (such as MFCCs) into text by decoding with an acoustic model and language model. The feature extraction module calculates emotion estimation feature values such as volume, fundamental frequency, speaking rate, and silence durations.

The input in this step is the user's raw voice signals.

The terminal performs time-domain and frequency-domain analysis (framing, windowing, Fourier transform, pitch detection, energy computation) on the digital signal and outputs a speech recognition result text string and a time-series of numerical emotion estimation feature vectors.

### Step 4:

The terminal packages and transmits multimodal data to the server.

The terminal assigns a session identifier to logically group the image data, the speech recognition result, and the emotion estimation feature vectors captured within a time window. The terminal serializes these data structures using a structured data format and encrypts them using a secure communication protocol.

The terminal selects a network interface (for example, cellular or wireless local area network) based on connection quality and sends the packets to the server via the communication interface.

The input in this step is the preprocessed image frames, the speech recognition result, and the emotion estimation feature vectors stored in the terminal memory.

The terminal performs serialization, encryption, and packetization operations on these inputs and outputs encrypted network packets containing the multimodal data and the session identifier.

### Step 5:

The server receives and reconstructs the transmitted data.

The server listens on a network port and receives encrypted packets via its communication interface.

The server decrypts the packets, verifies integrity, and deserializes the payload into internal data structures: a sequence of image frames, a speech recognition result string, and an array of emotion estimation feature vectors, all associated with the session identifier.

The input in this step is the stream of encrypted network packets sent from the terminal.

The server applies decryption, error checking, and deserialization algorithms to convert the packetized data into in-memory representations and outputs organized sets of image data, text data, and numerical feature data ready for further analysis.

### Step 6:

The server performs environment recognition on the image data.

The server feeds each image frame into an environment recognition unit implemented using a deep learning framework.

The server applies an object detection model to generate bounding boxes and class labels for objects such as furniture, appliances, doors, stairs, and obstacles.

The server applies a face detection algorithm to locate faces and a face embedding model to extract feature vectors, which the server compares with stored reference vectors to identify known persons.

The server detects potential text regions and applies a character recognition engine to convert those regions into machine-readable text.

The input in this step is the preprocessed image frames.

The server performs convolutional and matrix operations, region proposals, similarity computations, and pattern recognition to transform raw pixel matrices into structured environment data, and outputs an environment recognition result that includes at least object types and positions, identified persons, and recognized text strings.

### Step 7:

The server estimates the user's emotional state.

The server inputs the time-series of emotion estimation feature vectors, and optionally facial expression feature values derived from images, into an emotion estimation unit.

The server normalizes each feature dimension and feeds the sequences into a time-series classification model, such as a recurrent neural network.

The model outputs scores for predefined emotion categories. The server applies a softmax function to obtain probabilities, selects the category with the highest probability as the current emotional state, and stores the label and probabilities in association with a time stamp.

The server updates an emotional history for the user and may compute long-term trend indicators such as persistent anxiety.

The input in this step is the time-ordered feature vectors from audio (and optionally facial expression feature vectors).

The server performs normalization, sequence modeling, and probabilistic classification to convert numerical feature sequences into an emotional state representation and outputs an emotion state object containing at least the current emotion label, confidence scores, and trend information.

### Step 8:

The server generates a structured prompt sentence for the generative AI model.

The server provides the environment recognition result, the emotional state, and the speech recognition result to the prompt generation unit.

The server selects an appropriate template based on conditions such as whether the user is moving, whether obstacles are present, whether a schedule-related question was recognized, and whether a long-term negative emotional trend exists.

The server fills placeholders in the template with concrete values (for example, object type, distance, room name, recognized question text, schedule time, emotion label, and trend description).

The server concatenates the filled text segments to create a coherent prompt sentence that includes a description part and an instruction part specifying output language, tone, maximum number of sentences, and content constraints for the generative AI model.

The input in this step is the structured environment recognition result, the emotion state object, and the speech recognition result.

The server performs rule-based template selection, field mapping, and string construction on these inputs and outputs a complete prompt sentence to be used as the query to the generative AI model.

### Step 9:

The server invokes the generative AI model to produce guidance or dialogue text.

The server tokenizes the prompt sentence into a sequence of tokens using the tokenizer associated with a large-scale neural network language model.

The server feeds the token sequence into the generative AI model, which performs a sequence of matrix multiplications, self-attention operations, and nonlinear activations to compute probability distributions over the vocabulary for successive output tokens.

The server generates tokens iteratively according to configured parameters (e.g., maximum length, temperature, top-p) until completion, then decodes the tokens back to text.

The result is guidance text, such as navigation instructions, or dialogue response text answering the user's question in a tone adapted to the user's emotional state.

The input in this step is the prompt sentence.

The server applies tokenization, neural sequence modeling, and probabilistic sampling to transform the textual prompt into new natural language content and outputs a finalized text string usable for subsequent speech synthesis.

### Step 10:

The server synthesizes audio from the generated text.

The server passes the guidance text or dialogue response text to a speech synthesis unit configured with voice characteristics and prosodic parameters selected according to the emotional state (for example, slower, calmer voice for anxiety).

The server uses a text-to-speech engine to convert the input text into phonetic and prosodic features, then uses an acoustic model and a vocoder to generate a digital audio waveform.

The server may compress this waveform using an audio codec to reduce size before transmission.

The input in this step is the generated text string and emotion-dependent synthesis parameters. The server performs linguistic analysis, acoustic parameter prediction, and waveform generation to convert the text and parameters into digital audio data, and outputs audio frames representing synthesized speech.

### Step 11:

The server transmits the synthesized audio data to the terminal.

The server segments the audio data into packets, attaches the session identifier and timing information, and encrypts the packets using a secure protocol.

The server sends the packets over the network via its communication interface and monitors acknowledgments or transmission status.

The input in this step is the continuous audio data generated by the speech synthesis unit.

The server applies packetization, encryption, and network transmission procedures to transform the audio stream into a series of network packets and outputs those packets onto the communication path toward the terminal.

### Step 12:

The terminal receives, reconstructs, and plays the audio to the user.

The terminal receives the encrypted packets via its wireless communication interface and applies decryption and reassembly to restore the continuous digital audio stream.

The terminal decodes the compressed audio if necessary, then sends the decoded samples to a digital-to-analog converter and drives the bone conduction output device.

The terminal may measure ambient noise and adjust output volume or apply noise cancellation algorithms to improve intelligibility.

The input in this step is the stream of encrypted audio packets from the server.

The terminal performs decryption, depacketization, decoding, and digital-to-analog conversion to transform the packets into an analog vibration signal, and outputs this signal through the bone conduction device so that the user perceives synthesized spoken guidance or responses.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

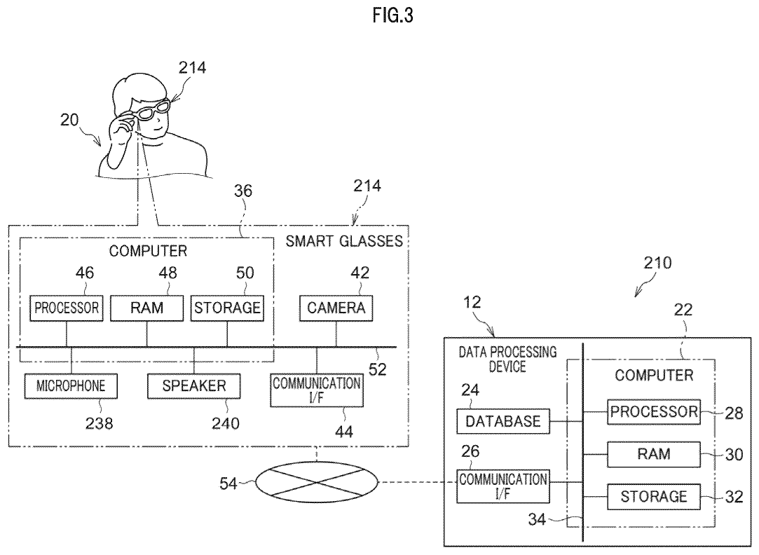

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

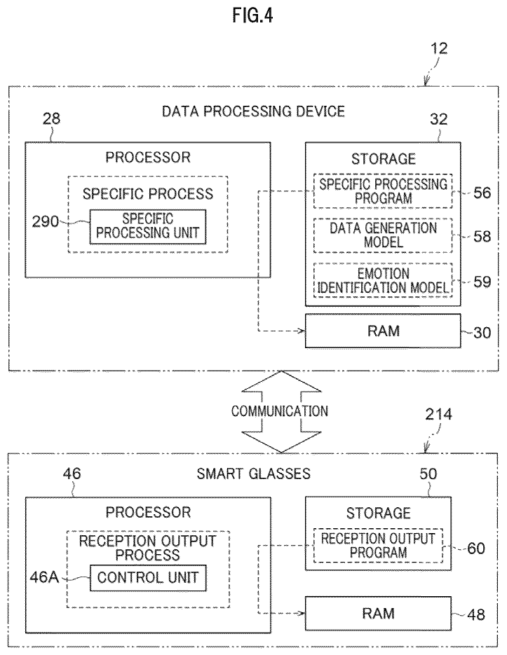

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

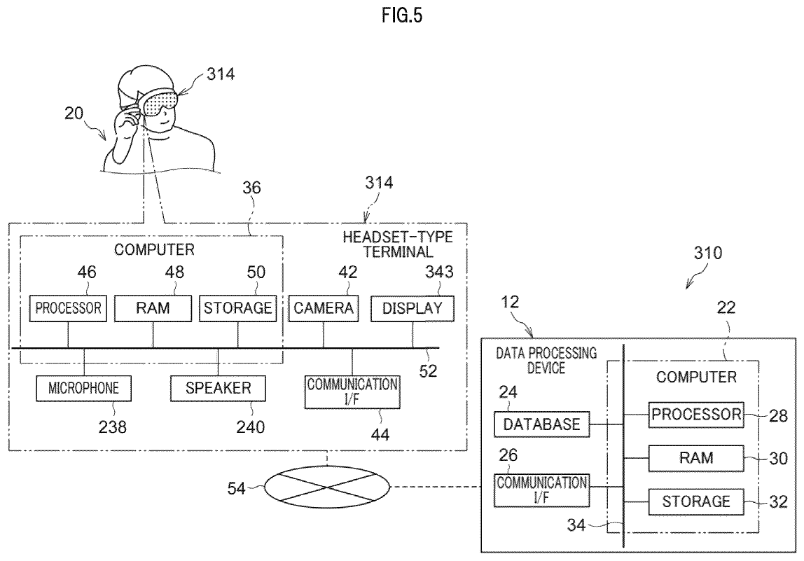

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

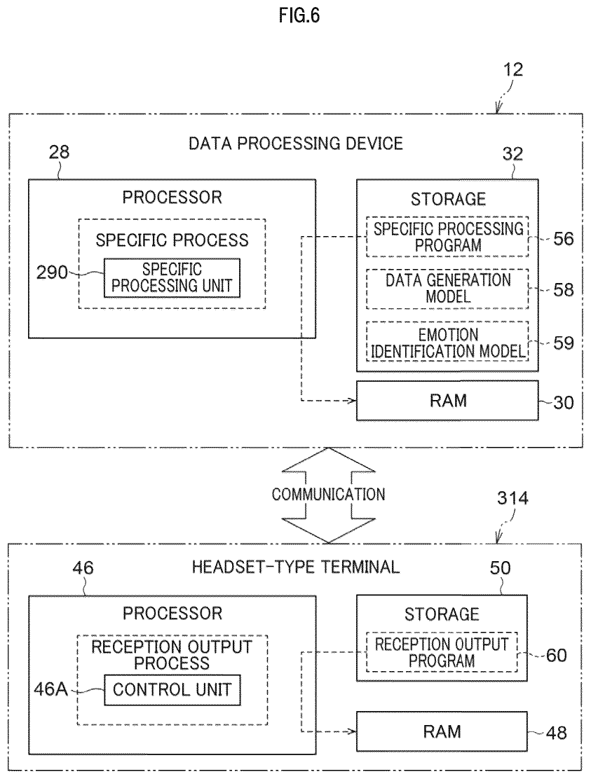

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

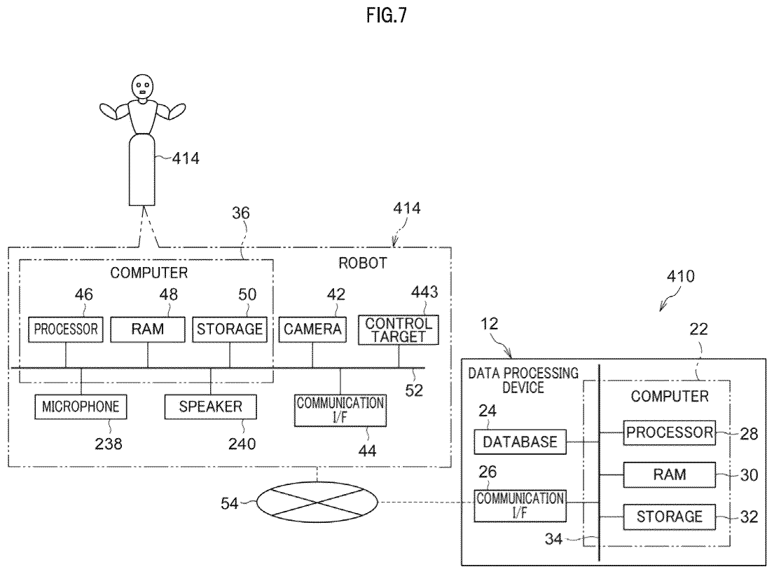

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

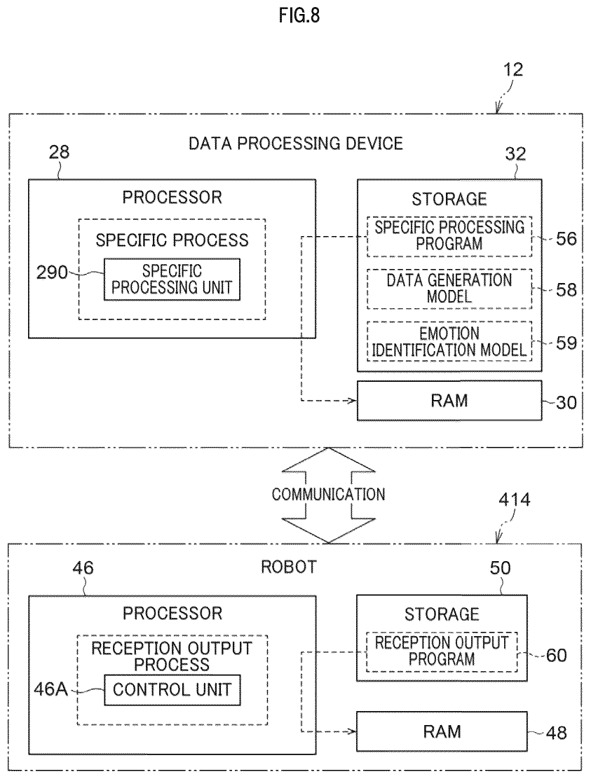

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

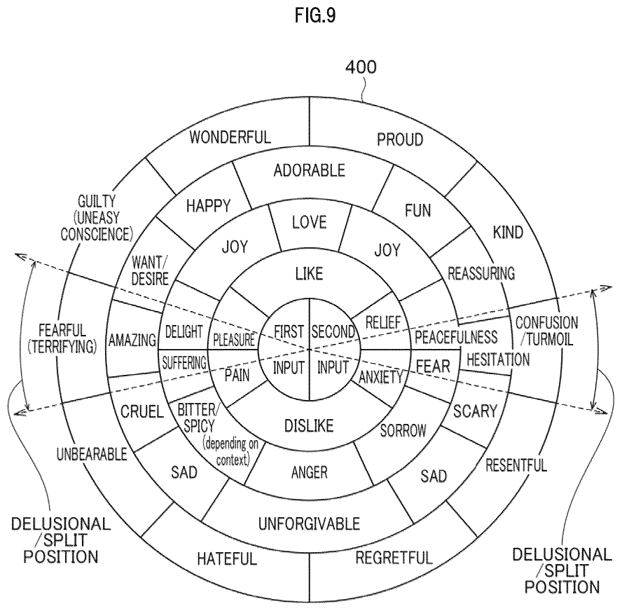

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

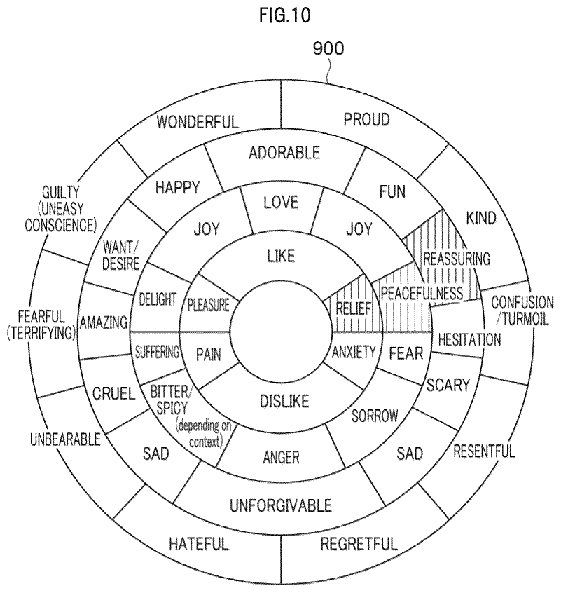

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
control an imaging device that continuously captures an environment around a user and generates environment image data,
transmit the environment image data obtained from the imaging device to an information processing apparatus via a communication line, and receive audio data transmitted from the information processing apparatus,
execute learned discrimination processing including object recognition processing, person face recognition processing, and character recognition processing on the environment image data, integrate recognition results over time, and generate structured scene information including a type, a position, and a distance of an object, presence or absence and a relative position of a known person, and character information,
generate scene interpretation information by selecting types and priorities of targets based on the structured scene information and user attribute information, and by prioritizing safety-related information,
generate a prompt sentence as text-format input data for a generative AI model based on the scene interpretation information and dialogue history information, and cause the generative AI model to generate a natural-language guidance text in response to the prompt sentence,
convert the guidance text into an audio signal and output the audio signal to the user via an acoustic output device of a bone-conduction type,
acquire utterance audio of the user, convert the utterance audio into a character string by speech recognition processing, extract requested content of the user by intent analysis processing, generate dialogue response information by integrating information acquired from an external information source or an internal information source with the structured scene information, input the dialogue response information as a prompt sentence to the generative AI model, cause the generative AI model to generate a response text, and output the response text by the acoustic output device, and
update a detail level, a priority, and a linguistic expression style of presented content in the scene interpretation information and the guidance text based on behavior history information of the user and past dialogue information, and perform personalized guidance provision control.

### (Supplementary 2)

The system according to supplementary 1,
wherein the processor is configured to perform, as the learned discrimination processing, preprocessing of the environment image data by using a discrimination-use learned model that is separate from the generative AI model, generate the structured scene information, input a prompt sentence including the structured scene information to the generative AI model, and perform verification processing of an output content of the generative AI model based on predetermined safety criteria and expression-length constraints before supplying the output content to an audio output process.

### (Supplementary 3)

The system according to supplementary 1,
wherein the processor is configured to, when the utterance audio from the user is determined to be a navigation request by the intent analysis processing, acquire route information to a destination by using a position information acquisition function and a route information acquisition function, generate the prompt sentence for the generative AI model based on the route information and the structured scene information, cause the generative AI model to generate a natural-language route guidance text in response to the prompt sentence, and cause the acoustic output device to output the route guidance text with priority.

### Application Example 1

### (Supplementary 1)

A system comprising a processor,
wherein the processor is configured to control an imaging apparatus to acquire surrounding environment information and to generate time-series image information for supporting independent living of a visually impaired user,
wherein the processor is configured to control a processing apparatus to recognize objects, persons, and character information based on the time-series image information and distance information from a distance information acquisition apparatus provided in association with the imaging apparatus, and to generate scene description information including position information and relative distance information of the objects, the persons, and the character information,
wherein the processor is configured to generate a prompt sentence to be input to a generative AI model based on the scene description information and user attribute information, to supply the prompt sentence to the generative AI model, and to cause the generative AI model to generate audio guidance text information,
wherein the processor is configured to control a speech synthesis apparatus to convert the audio guidance text information into an audio signal and to output the audio signal to the user via a bone-conduction type acoustic output apparatus,
wherein the processor is configured to control an acoustic input apparatus to collect utterance sound of the user, to acquire user instruction information based on the utterance sound, and to update at least part of the scene description information, the prompt sentence, and the audio guidance text information in accordance with the user instruction information, and
wherein the processor is configured to control a communication apparatus to encrypt and transmit and receive at least one of the time-series image information, the scene description information, and the audio guidance text information between a terminal device connected to the imaging apparatus and an information processing device in which the processing apparatus and the generative AI model are deployed.

### (Supplementary 2)

The system according to supplementary 1, wherein the processor is configured to, in generating the prompt sentence, add constraint information to the prompt sentence instructing the generative AI model to generate a short sentence including a warning statement and an avoidance direction based on obstacle position information and relative distance information included in the scene description information, and to verify whether a response sentence output from the generative AI model does not contradict the scene description information, and, when a contradiction is detected, to request regeneration by changing the constraint information.

### (Supplementary 3)

The system according to supplementary 1,
wherein the processor is configured to acquire the user instruction information by recognizing, from the utterance sound of the user, a voice command including a schedule information inquiry instruction or a visitor information inquiry instruction, to obtain schedule information or visitor information corresponding to the voice command from an external information source or an internal storage device, to generate response scene description information including the obtained information, and to supply a prompt sentence including the response scene description information to the generative AI model so as to generate response audio guidance text information.

### Example 2

### (Supplementary 1)

A system comprising a processor,
wherein the processor is configured to
receive, from a wearable information terminal, image data representing a surrounding environment and position information associated with the image data, the image data being captured by an image acquisition unit provided in the wearable information terminal and including a series of frames with timestamps and location data,
receive, from the wearable information terminal, acoustic feature data representing utterance segments of a user, the acoustic feature data being generated by a voice acquisition unit provided in the wearable information terminal by performing voice activity detection and acoustic feature extraction on a voice signal of the user to obtain utterance interval information and a sequence of feature vectors,
receive, from the wearable information terminal, physiological information data representing at least heart activity, skin electrical activity, and body surface temperature of the user, the physiological information data being generated by a physiological information acquisition unit provided in the wearable information terminal by acquiring physiological signals from a biosignal acquisition mechanism or a short-range wireless communication mechanism and by applying smoothing processing to produce time-series physiological information,
deserialize, by a communication control function, an integrated sensor data packet transmitted from the wearable information terminal, the integrated sensor data packet including the image data, the acoustic feature data, the physiological information data, user identification information, and session information, and store structured data corresponding to the integrated sensor data packet in a memory,
perform, by an environment recognition unit, an environment recognition process on the image data, the environment recognition process including at least one of object detection processing, person detection processing, and character recognition processing using one or more machine learning models, to generate environment recognition result data including at least information on obstacles, steps, traffic signal indication states, persons, and character string information existing in the surrounding environment,
perform, by an emotion estimation unit, an emotion estimation process on the acoustic feature data and the physiological information data using a plurality of estimation models, the emotion estimation process including calculating an emotional state vector having elements representing at least an anxiety level, a stress level, a confusion level, and a relaxation level of the user, and generating, based on a predetermined decision rule applied to the emotional state vector, an emotion tag indicating at least a high-anxiety state or a relaxed state,
construct, by a prompt generation unit, a generation prompt sentence to be input to a generative artificial intelligence model, the prompt generation unit being configured to generate the generation prompt sentence in a natural language based on the environment recognition result data, the emotional state vector, the emotion tag, a voice command content received from the user, and profile information of the user, the generation prompt sentence including at least a role instruction to the generative artificial intelligence model, a description of the emotion tag, a summary of the environment recognition result data, and output conditions specifying at least one of a concise imperative style prioritizing safety-related information and a descriptive style including surrounding facility information,
execute, by a text generation unit, the generative artificial intelligence model including a transformer-type language model, the text generation unit being configured to tokenize the generation prompt sentence, input a sequence of tokens representing the generation prompt sentence to the generative artificial intelligence model, perform self-attention computation and sequential token generation to generate guide text for voice guidance or response text for dialogue, and output the generated text, and
transmit, by the communication control function, the generated guide text or the generated response text, together with the emotion tag and auxiliary metadata, to the wearable information terminal,
and wherein the wearable information terminal is configured to synthesize or reproduce audio based on the generated guide text or the generated response text and to output guidance audio to the user via a bone-conduction output mechanism.

### (Supplementary 2)

The system according to supplementary 1,
wherein the processor is configured to
determine environment context information based on the environment recognition result data and geographical information, the environment context information indicating at least one of an intersection vicinity, a staircase vicinity, a commercial area, and a quiet area,
select, based on the emotion tag and the environment context information, control parameters for the generation prompt sentence including at least an output style, an amount of information, and an information priority,
and generate, in a case where a danger level of the environment is high and the emotion tag indicates the high-anxiety state, the generation prompt sentence such that the generative artificial intelligence model is instructed to output, in a target language, one or more short imperative sentences including only safety-related guidance information, and generate, in a case where the danger level of the environment is low and the emotion tag indicates the relaxed state, the generation prompt sentence such that the generative artificial intelligence model is instructed to output, in the target language, a plurality of descriptive sentences including at least surrounding facility information and recommendation information.

### (Supplementary 3)

The system according to supplementary 1,
wherein the processor is configured to
perform, on the guide text or the response text generated by the generative artificial intelligence model, post-processing including at least one of prohibited-word removal processing, sentence-length adjustment processing, and style conversion processing,
transmit the post-processed guide text or the post-processed response text and the emotion tag to the wearable information terminal,
and cause the wearable information terminal to adjust, based on preset information of the user and a surrounding noise level measured by the wearable information terminal, at least one of an output volume, a frequency characteristic, and a noise suppression parameter, and to output the guidance audio through the bone-conduction output mechanism.

### Application Example 2

### (Supplementary 1)

A system comprising a processor,
wherein the processor is configured to
acquire, by an imaging unit, images of an environment around a user continuously and output the images as image data,
acquire, by an audio acquisition unit, uttered voice of the user and output the uttered voice as an audio signal,
extract, by an audio analysis unit, a speech recognition result and emotion estimation feature values from the audio signal,
transmit, by a transmission unit, the image data, the speech recognition result, and the emotion estimation feature values to a server via a communication path,
execute, by an environment recognition unit of the server, at least one of object recognition, person recognition, and character recognition on the image data to generate an environment recognition result as structured data,
estimate, by an emotion estimation unit of the server, an emotional state of the user on the basis of the emotion estimation feature values and, when available, facial expression feature values extracted from the image data,
generate, by a prompt generation unit of the server, a prompt sentence to be input to a generative AI model implemented by a large-scale neural network for generative processing, the prompt sentence being generated on the basis of the environment recognition result, the emotional state, and the speech recognition result,
generate, by a text generation unit of the server, guidance text or dialogue response text by inputting the prompt sentence to the generative AI model,
generate, by a speech synthesis unit of the server, audio data on the basis of at least one of the guidance text and the dialogue response text,
transmit, by an audio data transmission unit of the server, the audio data to a terminal of the user via the communication path, and
decode, by an audio output unit of the terminal, the audio data and output the decoded audio data to the user via a bone conduction output device.

### (Supplementary 2)

The system according to supplementary 1,
wherein the processor is configured to
estimate, by the emotion estimation unit, the emotional state of the user by inputting time-series data of the emotion estimation feature values and the facial expression feature values into a machine learning model to calculate scores corresponding to emotion categories including anxiety, joy, calmness, anger, and sadness, determine, as a current emotional state, an emotion category having a largest score, store a history of the determined emotional state, and cause the prompt generation unit to dynamically change instructions in the prompt sentence regarding tone and amount of information on the basis of a long-term emotional trend derived from the history.

### (Supplementary 3)

The system according to supplementary 1,
wherein the processor is configured to
cause the prompt generation unit to associate, in accordance with template information or rule information, at least one of an object type and an object position, a person identification result, and a character recognition result contained in the environment recognition result with the emotional state and the speech recognition result, and to generate the prompt sentence as a structured text including a description part that explains a current situation and a psychological state of the user and an instruction part that instructs the generative AI model regarding at least one of an output format, a language, a number of sentences, a tone, and content constraints.

What is claimed is:

1. A system comprising:
circuitry configured to:
receive, via a communication interface coupled to a packet-switched network, image data captured by an imaging device associated with a user;
execute learned discrimination processing on the image data using one or more discrimination-use learned models to perform object recognition, face recognition, and character recognition;
integrate recognition results to generate structured scene information including types, positions, and distances of recognized entities;
select and prioritize elements of the structured scene information on the basis of user attribute information to generate scene interpretation information;
generate a prompt sentence for a generative AI model on the basis of the scene interpretation information and dialogue history information;
input the prompt sentence to the generative AI model and obtain a natural-language guidance text;
verify the natural-language guidance text against predetermined safety criteria and expression-length constraints;
convert the verified guidance text into audio data; and
transmit the audio data via the packet-switched network for output by an acoustic output device.

2. The system according to claim 1, wherein the circuitry is configured to execute the object recognition by inputting the image data to a convolutional neural network including a backbone feature extractor with residual connections and a feature pyramid network, and to apply non-maximum suppression on resulting bounding boxes using an intersection-over-union threshold to produce a set of recognized object instances.

3. The system according to claim 2, wherein the circuitry is configured to compute distance values for each recognized object instance on the basis of bounding box dimensions and camera intrinsic parameters.

4. The system according to claim 1, wherein the circuitry is configured to execute the face recognition by detecting facial regions in the image data using a face detection model, mapping each detected facial region to an embedding vector using a metric-learning model, computing cosine similarity between the embedding vector and reference embedding vectors stored in a database, and determining that a detected face corresponds to a known person when the cosine similarity exceeds a predetermined threshold.

5. The system according to claim 4, wherein the circuitry is configured to execute the character recognition by detecting text regions in the image data using a text detection network, rectifying and normalizing each detected text region, and executing an optical character recognition model on each normalized text region to output recognized character strings with associated confidence values.

6. The system according to claim 1, wherein the structured scene information comprises a data structure in which each node represents a recognized entity having attributes including type, bounding coordinates, relative position, estimated distance, confidence score, and timestamp, and wherein the circuitry is configured to associate entity identifiers across successive frames using a multi-object tracking algorithm.

7. The system according to claim 6, wherein the multi-object tracking algorithm employs Kalman filtering and data association on the basis of spatial proximity and appearance similarity to produce temporally smoothed trajectories for moving entities.

8. The system according to claim 1, wherein the circuitry is configured to assign an importance score to each entity in the structured scene information on the basis of entity type, distance, relative motion, and recognition confidence, and to exclude or de-emphasize entities having a low importance score or entities that have been recently announced according to the dialogue history information.

9. The system according to claim 1, wherein the circuitry is configured to generate the prompt sentence by converting the scene interpretation information into a natural-language input sequence including an environment description segment, a user attribute segment specifying a language and a maximum phrase length, and a constraint instruction segment specifying an output format and content constraints for the generative AI model.

10. The system according to claim 9, wherein the circuitry is configured to verify the natural-language guidance text by parsing the guidance text into tokens, checking for prohibited terms, detecting ambiguous references lacking directional specificity, detecting conflicting action instructions, and verifying that a length of the guidance text does not exceed a configured limit, and wherein the circuitry is configured to apply a deterministic rewriting rule set or to generate a secondary prompt sentence with stronger constraints when one or more checks fail.

11. The system according to claim 1, wherein the circuitry is further configured to:
receive utterance audio from the user via the packet-switched network;
convert the utterance audio into a character string by speech recognition processing;
extract a requested content by intent analysis processing that classifies the character string into one of a plurality of intent categories; and
obtain information corresponding to the requested content from an external information source or an internal information source.

12. The system according to claim 11, wherein the circuitry is configured to integrate the obtained information with the structured scene information to generate dialogue response information, generate a further prompt sentence including the dialogue response information, input the further prompt sentence to the generative AI model to obtain a response text, and verify the response text according to the safety criteria prior to converting the response text into audio data.

13. The system according to claim 1, wherein the circuitry is further configured to, when an intent analysis of a user utterance identifies a navigation request, access route information from a map database, merge the route information with the structured scene information, and generate a navigation-oriented prompt sentence for the generative AI model that aligns route guidance with recognized obstacles and landmarks in the structured scene information.

14. The system according to claim 1, wherein the circuitry is configured to update, on the basis of behavior history information and past dialogue information, one or more control parameters that determine a detail level, a priority ordering, and a linguistic expression style of content included in subsequent scene interpretation information and prompt sentences, using a reinforcement-learning algorithm that maximizes a utility function reflecting a reduced interruption rate and improved compliance with safety instructions.

15. The system according to claim 1, wherein the acoustic output device comprises a bone-conduction transducer configured to transmit vibrations through bones of the user to an inner ear, thereby enabling the user to receive the audio data without blocking ambient environmental sounds.

16. The system according to claim 1, wherein the circuitry is further configured to estimate an emotional state of the user using an emotion identification model, and to adjust at least one of the scene interpretation information, the prompt sentence, and the linguistic expression style of the natural-language guidance text on the basis of the estimated emotional state.

17. The system according to claim 1, wherein the image data is received as a compressed video bitstream encoded by a hardware video encoder of the imaging device, and wherein the circuitry is configured to decode the compressed video bitstream using a multimedia decoding library, resize decoded frames to model-specific input dimensions, normalize pixel values, and batch consecutive frames into tensors for input to the one or more discrimination-use learned models.

18. A system comprising:
circuitry configured to:
receive, via a communication interface coupled to a packet-switched network, a compressed video bitstream captured by an imaging device having a wide-angle lens with a field of view of at least 120 degrees;
decode the compressed video bitstream and generate pre-processed frame tensors;
execute object recognition on the pre-processed frame tensors using a convolutional neural network including a backbone feature extractor with residual connections, a feature pyramid network, and a detection head, and apply non-maximum suppression to produce a set of object instances each having a bounding box, an object class, and a confidence score;
execute face recognition by detecting facial regions using a face detection model and mapping each facial region to an embedding vector using a metric-learning model, and determining identity by cosine similarity comparison against stored reference embedding vectors;
execute character recognition by detecting text regions, rectifying detected text regions, and executing an optical character recognition model to output recognized character strings;
integrate the object instances, face recognition results, and recognized character strings over time using a multi-object tracking algorithm with Kalman filtering to generate structured scene information;
assign importance scores to entities in the structured scene information on the basis of entity type, distance, relative motion, and recognition confidence, and select prioritized entities to generate scene interpretation information;
construct a prompt sentence for a transformer-based generative AI model, the prompt sentence including an environment description derived from the scene interpretation information, user attribute constraints specifying language and maximum output length, and safety formatting instructions;
input the prompt sentence to the transformer-based generative AI model and obtain a natural-language guidance text;
verify the natural-language guidance text by checking for prohibited terms, ambiguous references, conflicting instructions, and length compliance, and apply corrective rewriting or regeneration when verification fails;
convert the verified guidance text into audio data using a neural text-to-speech model; and
transmit the audio data via the packet-switched network for output by a bone-conduction acoustic output device.

19. The system according to claim 18, wherein the circuitry is further configured to receive utterance audio from a user via the packet-switched network, convert the utterance audio into text by speech recognition processing using an encoder-decoder neural network, classify the text into an intent category by intent analysis processing, obtain information corresponding to the intent category, integrate the obtained information with the structured scene information to generate a dialogue-oriented prompt sentence, and input the dialogue-oriented prompt sentence to the transformer-based generative AI model to obtain a response text for audio conversion and transmission.

20. A method performed by circuitry of a system, the method comprising:
receiving, via a communication interface coupled to a packet-switched network, image data captured by an imaging device associated with a user;
executing learned discrimination processing on the image data using one or more discrimination-use learned models to perform object recognition, face recognition, and character recognition;
integrating recognition results to generate structured scene information including types, positions, and distances of recognized entities;
selecting and prioritizing elements of the structured scene information on the basis of user attribute information to generate scene interpretation information;
generating a prompt sentence for a generative AI model on the basis of the scene interpretation information and dialogue history information;
inputting the prompt sentence to the generative AI model and obtaining a natural-language guidance text;
verifying the natural-language guidance text against predetermined safety criteria and expression-length constraints;
converting the verified guidance text into audio data; and
transmitting the audio data via the packet-switched network for output by an acoustic output device.
